(19) United States
(12) Patent Application Publication
(10) Pub. No.: US 2026/0298842 A1
(43) Pub. Date: Oct. 1, 2026

(54) ENDOSCOPE SYSTEM, INFORMATION NOTIFICATION METHOD, AND RECORDING MEDIUM

(71) Applicant: Evident Inspection Technologies Japan Corporation, Tatsuno-machi (JP)

(72) Inventor: Yukiyoshi YAGI, Kamiina-gun (JP)

(73) Assignee: Evident Inspection Technologies Japan Corporation, Tatsuno-machi (JP)

(21) Appl. No.: 19/430,326

(22) Filed: Dec. 23, 2025

(30) Foreign Application Priority Data
Mar. 27, 2025 (JP) 2025-053913

(51) Int. Cl. G01N 21/954; H04N 23/50; G06F 3/0338; G06F 3/038

(52) U.S. Cl. CPC G01N 21/954; H04N 23/555; G06F 3/0338; G06F 3/0383; G06F 2203/0384

(57) ABSTRACT

An endoscope system includes an endoscope device and an external device. At least one of a first processor of the endoscope device and a second processor of the external device executes a determination process of determining whether the external device is stored in a storage portion and whether the external device is being operated based on at least one of first operation information and first state information in the endoscope device and second operation information and second state information in the external device. When it is determined that the external device is not stored in the storage portion and the external device is not being operated, at least one of the first processor and the second processor causes a notification circuit included in the endoscope device or the external device to execute notification of information.

### BACKGROUND OF THE INVENTION

### Field of Invention

The present invention relates to an endoscope system, an information notification method, and a recording medium.

Priority is claimed on Japanese Patent Application No. 2025-053913, filed Mar. 27, 2025, the content of which is incorporated herein by reference.

### Description of Related Art

Industrial endoscope devices have been used for inspection for abnormality, corrosion, and the like in boilers, pipes, aircraft engines, and the like. An endoscope device includes an insertion unit for acquiring an image. A user inserts the insertion unit into a subject and acquires an image of an inspection region in the subject. The user observes the image and inspects the inspection region. The insertion unit includes a bending portion for bending the insertion unit. The user can bend the insertion unit by performing a bending operation.

Japanese Unexamined Patent Application, First Publication No. 2001-272609 discloses a remote controller that receives an operation on an endoscope device. The remote controller is connected to a main body of the endoscope device via a cable.

### SUMMARY OF THE INVENTION

According to an aspect of the present invention, an endoscope system includes an endoscope device and an external device. The endoscope device includes an insertion unit, a first operation device, a first processor, and a first communicator. The insertion unit is bendable and acquires an optical image in an observation target. The first operation device receives an operation including a bending operation for bending the insertion unit. The first processor acquires at least one of first operation information and first state information. The first operation information indicates an operation received by the first operation device, and the first state information indicates a state of the endoscope device. The first communicator executes wireless communication associated with control of the endoscope device. The external device includes a second operation device, a second sensor, a second processor, and a second communicator. The second operation device receives an operation including the bending operation. The second sensor determines a state of the external device. The second processor acquires second operation information and second state information. The second operation information indicates the operation received by the second operation device, and the second state information indicates the state determined by the second sensor. The second communicator executes the wireless communication. At least one of the first processor and the second processor executes a determination process of determining whether the external device is stored in a storage portion and whether the external device is being operated based on at least one of the first operation information and the first state information and based on the second operation information and the second state information. At least one of the first processor and the second processor causes a notification circuit included in the endoscope device or the external device to execute notification of information when it is determined that the external device is not stored in the storage portion and the external device is not being operated. The second communicator transmits the second operation information and the second state information to the first communicator when the first processor executes the determination process. The first communicator transmits at least one of the first operation information and the first state information to the second communicator when the second processor executes the determination process.

According to an aspect of the present invention, the endoscope device may further include a first sensor that determines a state of the endoscope device. At least one of the first processor and the second processor may execute the determination process based on at least one of the first operation information and the first state information indicating the state determined by the first sensor and based on the second operation information and the second state information.

According to an aspect of the present invention, the first sensor may determine a moving state of the endoscope device.

According to an aspect of the present invention, the second sensor may determine a moving state of the external device and a posture of the external device.

According to an aspect of the present invention, at least one of the first processor and the second processor may execute the determination process based on at least one of the first operation information and the first state information and based on the second operation information and the second state information indicating whether the external device is stationary in a preset posture.

According to an aspect of the present invention, the endoscope device may further include a first sensor that determines a posture of the endoscope device. The first communicator may transmit information indicting the posture determined by the first sensor to the second communicator. The second processor may set a threshold value based on the posture indicated by the information received by the second communicator. The second processor may generate the second state information indicating whether the external device is stationary in the preset posture based on the posture determined by the second sensor and the threshold value.

According to an aspect of the present invention, at least one of the first processor and the second processor may execute the determination process based on at least one of the first operation information and the first state information indicating a state of wireless connection between the first communicator and the second communicator and based on the second operation information and the second state information.

According to an aspect of the present invention, the first communicator may continuously transmit a signal to the second communicator. The second processor may execute the determination process when the second communicator does not receive the signal from the first communicator.

According to an aspect of the present invention, at least one of the first processor and the second processor may execute the determination process based on at least one of the first operation information indicating the bending operation or an operation on an application in the endoscope device and the first state information and based on the second operation information and the second state information.

According to an aspect of the present invention, at least one of the first processor and the second processor may cause the notification circuit to continuously execute the notification of information after the notification has been started. At least one of the first processor and the second processor may determine whether the notification of information is to end based on at least one of the second operation information and the second state information. At least one of the first processor and the second processor may cause the notification circuit to end the notification of information when it is determined that the notification of information is to end.

According to an aspect of the present invention, the endoscope device may further include a global positioning system (GPS) sensor that determines a position of the endoscope device. The first communicator may transmit information indicating the position to the second communicator when the second processor executes the determination process. At least one of the first processor and the second processor may control the notification executed by the notification circuit based on the position.

According to an aspect of the present invention, at least one of the first processor and the second processor may control the notification executed by the notification circuit based on a current time.

According to an aspect of the present invention, the second communicator may transmit the second operation information and the second state information to the first communicator. The first processor may execute the determination process.

According to an aspect of the present invention, the second processor may determine an execution state of inspection in the external device based on the second operation information and the second state information. The second communicator may transmit state information indicating the execution state to the first communicator. The first processor may execute the determination process based on at least one of the first operation information and the first state information and based on the state information received by the first communicator.

According to an aspect of the present invention, the first communicator may transmit at least one of the first operation information and the first state information to the second communicator. The second processor may execute the determination process.

According to an aspect of the present invention, the first processor may determine an execution state of inspection in the endoscope device based on at least one of the first operation information and the first state information. The first communicator may transmit state information indicating the execution state to the second communicator. The second processor may execute the determination process based on the state information received by the second communicator, the second operation information, and the second state information.

According to the aspect of the present invention, the endoscope device may further include a first housing to which the insertion unit is connected and a second housing including the first operation device and the first processor.

According to an aspect of the present invention, the endoscope device may include a housing to which the insertion unit is connected and in which the first operation device and the first processor are stored.

According to an aspect of the present invention, the second operation device may include a joystick that receives the bending operation.

According to an aspect of the present invention, an information notification method is provided. A first processor of an endoscope device acquires at least one of first operation information and first state information. The first operation information indicates an operation received by a first operation device that receives an operation including a bending operation for bending an insertion unit that is bendable and acquires an optical image in an observation target. The first state information indicates a state of the endoscope device. A second processor of an external device acquires second operation information and second state information. The second operation information indicates an operation received by a second operation device that receives an operation including the bending operation in the external device. The second state information indicates a state determined by a second sensor of the external device. At least one of the first processor and the second processor executes a determination process of determining whether the external device is stored in a storage portion and whether the external device is being operated based on at least one of the first operation information and the first state information and based on the second operation information and the second state information. At least one of the first processor and the second processor causes a notification circuit included in the endoscope device or the external device to execute notification of information when it is determined that the external device is not stored in the storage portion and the external device is not being operated. A second communicator that executes wireless communication associated with control of the endoscope device transmits the second operation information and the second state information to a first communicator that executes the wireless communication when the first processor executes the determination process. The first communicator transmits at least one of the first operation information and the first state information to the second communicator when the second processor executes the determination process.

According to an aspect of the present invention, there is provided a non-transitory computer-readable recording medium storing a program causing a computer of an endoscope device to execute processing. The computer acquires at least one of first operation information and first state information. The first operation information indicates an operation received by a first operation device that receives an operation including a bending operation for bending an insertion unit that is bendable and acquires an optical image in an observation target. The first state information indicates a state of the endoscope device. The computer causes a first communicator that executes wireless communication associated with control of the endoscope device with a second communicator of an external device to receive second operation information and second state information. The second operation information indicates an operation received by a second operation device that receives an operation including the bending operation in the external device. The second state information indicates a state determined by a second sensor of the external device. The computer executes a determination process of determining whether the external device is stored in a storage portion and whether the external device is being operated based on at least one of the first operation information and the first state information and based on the second operation information and the second state information. The computer causes a notification circuit included in the endoscope device or the external device to execute notification of information when it is determined that the external device is not stored in the storage portion and the external device is not being operated.

According to an aspect of the present invention, there is provided a non-transitory computer-readable recording medium storing a program causing a computer of an external device to execute processing. The computer causes a second communicator that executes wireless communication associated with control of an endoscope device with a first communicator of the endoscope device to receive at least one of first operation information and first state information. The first operation information indicates an operation received by a first operation device that receives an operation including a bending operation for bending an insertion unit that is bendable and acquires an optical image in an observation target. The first state information indicates a state of the endoscope device. The computer acquires second operation information and second state information. The second operation information indicates an operation received by a second operation device that receives an operation including the bending operation in the external device. The second state information indicates a state determined by a second sensor of the external device. The computer executes a determination process of determining whether the external device is stored in a storage portion and whether the external device is being operated based on at least one of the first operation information and the first state information and based on the second operation information and the second state information. The computer causes a notification circuit included in the endoscope device or the external device to execute notification of information when it is determined that the external device is not stored in the storage portion and the external device is not being operated.

### BRIEF DESCRIPTION OF THE DRAWINGS

FIG. 1 is a block diagram showing an example of the configuration of an endoscope system according to a first embodiment of the present invention.

FIG. 2 is a block diagram showing an example of the configuration of an endoscope device according to the first embodiment of the present invention.

FIG. 3 is a block diagram showing an example of the configuration of an external device according to the first embodiment of the present invention.

FIG. 4 is a front view and a side view of the external device according to the first embodiment of the present invention.

FIG. 5 is a diagram showing an example of a state in which the external device is stored in a main unit in the endoscope system according to the first embodiment of the present invention.

FIG. 6 is a diagram showing a first example of an inspection flow and device states in the first embodiment of the present invention.

FIG. 7 is a diagram showing a second example of an inspection flow and device states in the first embodiment of the present invention.

FIG. 8 is a diagram showing a third example of an inspection flow and device states in the first embodiment of the present invention.

FIG. 9 is a diagram showing a fourth example of an inspection flow and device states in the first embodiment of the present invention.

FIG. 10 is a diagram showing an example of device states and inspection scenes according to the first embodiment of the present invention.

FIG. 11 is a diagram showing an example of device states of the endoscope system in the first embodiment of the present invention.

FIG. 12 is a diagram showing an example of device states of the external device according to the first embodiment of the present invention.

FIG. 13 is a diagram showing an example of a relationship between information acquired by the endoscope device and the external device and inspection scenes in the first embodiment of the present invention.

FIG. 14 is a diagram showing an example of a main state in which there is a likelihood that a user has forgotten carrying the external device in the first embodiment of the present invention.

FIG. 15 is a diagram showing an example of a situation in which notification of a user is necessary in the first embodiment of the present invention.

FIG. 16 is a diagram showing an example of a situation in which notification of a user is necessary in the first embodiment of the present invention.

FIG. 17 is a diagram showing a first example in which processes are shared by a control unit of the endoscope device and a control unit of the external device in the first embodiment of the present invention.

FIG. 18 is a diagram showing a second example in which processes are shared by the control unit of the endoscope device and the control unit of the external device in the first embodiment of the present invention.

FIG. 19 is a diagram showing a third example in which processes are shared by the control unit of the endoscope device and the control unit of the external device in the first embodiment of the present invention.

FIG. 20 is a diagram showing a fourth example in which processes are shared by the control unit of the endoscope device and the control unit of the external device in the first embodiment of the present invention.

FIG. 21 is a diagram showing a fifth example in which processes are shared by the control unit of the endoscope device and the control unit of the external device in the first embodiment of the present invention.

FIG. 22 is a diagram showing a sixth example in which processes are shared by the control unit of the endoscope device and the control unit of the external device in the first embodiment of the present invention.

FIG. 23 is a diagram showing a seventh example in which processes are shared by the control unit of the endoscope device and the control unit of the external device in the first embodiment of the present invention.

FIG. 24 is a diagram showing an eighth example in which processes are shared by the control unit of the endoscope device and the control unit of the external device in the first embodiment of the present invention.

FIG. 25 is a flowchart showing an example of a procedure of a process executed by the endoscope device according to the first embodiment of the present invention.

FIG. 26 is a flowchart showing an example of a procedure of a process executed by the external device according to the first embodiment of the present invention.

FIG. 27 is a diagram showing an example of a posture of the external device according to the first embodiment of the present invention.

FIG. 28 is a diagram showing an example of the change of a count value, the change of a device state of the external device, and the change of an execution state of notification of a user in the first embodiment of the present invention.

FIG. 29 is a flowchart showing an example of a procedure of a process executed by the endoscope device according to the first embodiment of the present invention.

FIG. 30 is a flowchart showing an example of a procedure of a process executed by the endoscope device according to the first embodiment of the present invention.

FIG. 31 is a flowchart showing an example of a procedure of a process executed by the endoscope device according to the first embodiment of the present invention.

FIG. 32 is a block diagram showing an example of the configuration of an endoscope system according to a first modified example of the first embodiment of the present invention.

FIG. 33 is a block diagram showing an example of the configuration of an endoscope system according to a second modified example of the first embodiment of the present invention.

FIG. 34 is a flowchart showing an example of a procedure of a process executed by an endoscope device according to a third modified example of the first embodiment of the present invention.

FIG. 35 is a flowchart showing an example of a procedure of a process executed by an external device according to the third modified example of the first embodiment of the present invention.

FIG. 36 is a diagram showing an example of device states and inspection scenes in a second embodiment of the present invention.

FIG. 37 is a diagram showing an example of a situation in which notification of a user is necessary in the second embodiment of the present invention.

FIG. 38 is a flowchart showing an example of a procedure of a process executed by the endoscope device according to the second embodiment of the present invention.

FIG. 39 is a diagram showing an example of device states in a third embodiment of the present invention.

FIG. 40 is a diagram showing an example of a situation in which notification of a user is necessary in the third embodiment of the present invention.

FIG. 41 is a flowchart showing an example of a procedure of a process executed by the external device according to the third embodiment of the present invention.

### DETAILED DESCRIPTION OF THE INVENTION

Hereinafter, embodiments of the present invention will be described with reference to the drawings.

### First embodiment

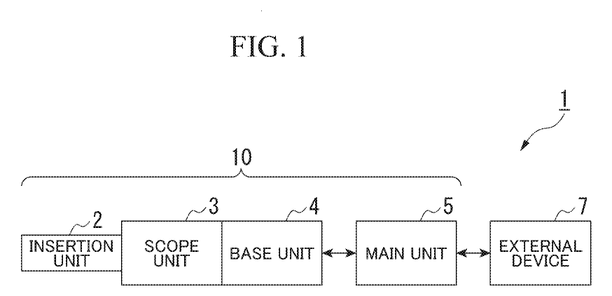

FIG. 1 shows an example of the configuration of an endoscope system 1 according to a first embodiment of the present invention. The endoscope system 1 shown in FIG. 1 includes an insertion unit 2, a scope unit 3, a base unit 4, a main unit 5, and an external device 7. The insertion unit 2, the scope unit 3, the base unit 4, and the main unit 5 constitute an endoscope device 10. The external device 7 is a wireless remote controller. The external device 7 is disposed outside the endoscope device 10 and is separated from the endoscope device 10.

The insertion unit 2 is connected to the scope unit 3. The scope unit 3 and the base unit 4 are connected to each other. The base unit 4 and the main unit 5 execute wired communication or wireless communication with each other. The main unit 5 and the external device 7 execute wireless communication with each other.

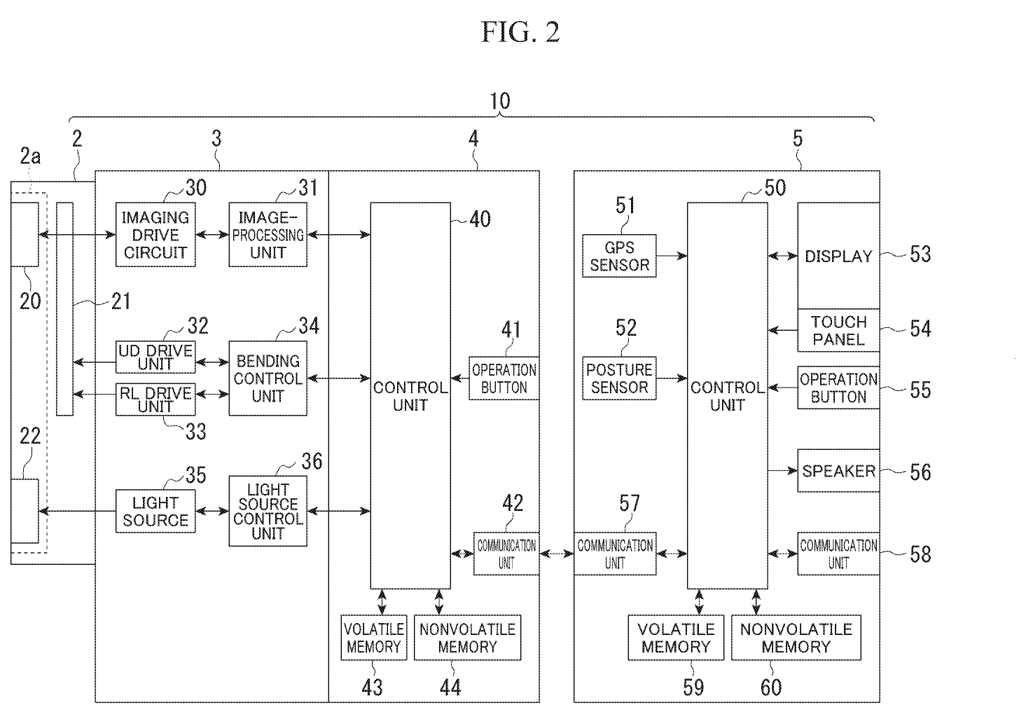

FIG. 2 shows an example of the configuration of the endoscope device 10. The insertion unit 2 is inserted into a subject which is an observation target. The subject is an industrial product. The insertion unit 2 has a thin and long tube shape and is bendable. A user performs an insertion operation and inserts the insertion unit 2 into the subject. The insertion unit 2 acquires an optical image in the subject. The insertion unit 2 includes an imaging unit 20, a bending portion 21, and an illumination window 22.

The imaging unit 20 is disposed in a distal end portion 2a including the distal end of the insertion unit 2. The imaging unit 20 is an image sensor such as a charge-coupled device (CCD) image sensor or a complementary metal-oxide-semiconductor (CMOS) image sensor. The imaging unit 20 generates an image based on an optical image acquired by the insertion unit 2. The image generated by the imaging unit 20 is output to the scope unit 3.

The bending portion 21 bends the insertion unit 2 upward (U), downward (D), leftward (L), or rightward (R). Alternatively, the bending portion 21 bends the insertion unit 2 up-leftward (UL), up-rightward (UR), down-leftward (DL), or down-rightward (DR).

Illumination light is generated by a light source 35 disposed in the scope unit 3 and is output to the distal end portion 2a via a light guide disposed in the insertion unit 2. The illumination light is emitted to the inside of the subject via the illumination window 22.

The scope unit 3 includes an imaging drive circuit 30, an image-processing unit 31, a UD drive unit 32, an RL drive unit 33, a bending control unit 34, a light source 35, and a light source control unit 36. The base unit 4 includes a control unit 40, an operation button 41, a communication unit 42, a volatile memory 43, and a nonvolatile memory 44.

The imaging drive circuit 30 controls the imaging unit 20 such that an image output from the imaging unit 20 is output to the image-processing unit 31. The image-processing unit 31 executes image processing such as noise reduction on the image output from the imaging unit 20 and outputs the image to the control unit 40.

The UD drive unit 32 is connected to a UD bending wire for bending the bending portion 21 in the U direction or the D direction. The UD drive unit 32 includes a motor and bends the bending portion 21 in the U direction or the D direction by pulling the UD bending wire. The RL drive unit 33 is connected to an RL bending wire for bending the bending portion 21 in the R direction or the L direction. The RL drive unit 33 includes a motor and bends the bending portion 21 in the R direction or the L direction by pulling the RL bending wire. The bending control unit 34 controls the UD drive unit 32 and the RL drive unit 33.

The UD drive unit 32 and the RL drive unit 33 can operate simultaneously. For example, the UD drive unit 32 and the RL drive unit 33 can bend the bending portion 21 in the UL direction.

The light source 35 is a light-emitting diode (LED) or the like and generates illumination light. The illumination light is output to the light guide from the light source 35. The light source control unit 36 controls the light source 35.

The control unit 40 controls each unit of the scope unit 3 and the base unit 4. At least one of the control unit 40, the image-processing unit 31, the bending control unit 34, and the light source control unit 36 may be constituted by at least one of a processor and a logic circuit. For example, the processor is at least one of a central processing unit (CPU), a digital signal processor (DSP), and a graphics-processing unit (GPU). For example, the logic circuit is at least one of an application-specific integrated circuit (ASIC) and a field-programmable gate array (FPGA). At least one of the control unit 40, the image-processing unit 31, the bending control unit 34, and the light source control unit 36 may include one or more processors. At least one of the control unit 40, the image-processing unit 31, the bending control unit 34, and the light source control unit 36 may include one or more logic circuits.

A computer of the endoscope system 1 may read a program and execute the read program. The program includes instructions for prescribing an operation of at least one of the control unit 40, the image-processing unit 31, the bending control unit 34, and the light source control unit 36. That is, the function of at least one of the control unit 40, the image-processing unit 31, the bending control unit 34, and the light source control unit 36 may be realized by software.

The program may be provided, for example, using a “computer-readable recording medium” such as a flash memory. The program may be transmitted from a computer storing the program to the endoscope system 1 via a transmission medium or using carrier waves in the transmission medium. The “transmission medium” for transmitting a program is a medium having a function of transmitting information. The medium having a function of transmitting information includes a network (a communication network) such as the Internet and a communication circuit line (a communication line) such as a telephone line. The program may realize some of the above-described functions. The program may be a differential file (a differential program). The above-described functions may be realized in combination of the differential program with a program recorded in advance in the computer.

An operation button 41 receives various instructions from a user. The user can input instructions associated with power supply or illumination to the endoscope system 1 by pressing the operation button 41.

The communication unit 42 includes a communication circuit and executes wired communication or wireless communication for bending control with the main unit 5. The volatile memory 43 is a random access memory (RAM), a dynamic RAM (DRAM), or the like. The volatile memory 43 stores various kinds of information processed by the control unit 40. The nonvolatile memory 44 is a static RAM (SRAM), an erasable programmable read-only memory (EPROM), an electrically erasable programmable ROM (EEPROM), or a flash memory. The nonvolatile memory 44 may be attachable to and detachable from the base unit 4. The nonvolatile memory 44 stores an image generated by the imaging unit 20 and various kinds of information processed by the control unit 40.

The main unit 5 includes a control unit 50, a global positioning system (GPS) sensor 51, a posture sensor 52, a display 53, a touch panel 54, an operation button 55, a speaker 56, a communication unit 57, a communication unit 58, a volatile memory 59, and a nonvolatile memory 60. The main unit 5 may be an information terminal such as a smartphone or a table terminal.

The control unit 50 controls each unit of the main unit 5. The control unit 50 may be constituted by at least one of a processor and a logic circuit. The control unit 50 may include one or more processors. The control unit 50 may include one or more logic circuits. The computer of the endoscope system 1 may read a program and execute the read program. The program includes instructions for prescribing an operation of the control unit 50. That is, the function of the control unit 50 may be realized by software. The program for realizing the function of the control unit 50 may be realized in the same way as the program for realizing the function of the control unit 40 and the like.

The GPS sensor 51 determines the position of the main unit 5. The determined position is used as a position of the endoscope device 10 for various processes.

For example, the posture sensor 52 is a combination of an acceleration sensor and a gyro sensor. The posture sensor 52 determines the motion state of the main unit 5. The determined state is used as a motion state of the endoscope device 10 for various processes.

The display 53 is a monitor such as a liquid crystal display (LCD). The display 53 displays an image generated by the imaging unit 20. In addition, the display 53 receives an operation for inputting information required for bending control of the insertion unit 2. The touch panel 54 is disposed on a screen of the display 53. A user can input an instruction to change settings of the endoscope system 1, an instruction required for operating the endoscope system 1, and the like to the endoscope system 1 by operating the touch panel 54. Specifically, the instruction required for operating the endoscope system 1 is a bending operation instruction for bending control, an instruction to operate a menu, or the like.

A user performs an operation such as a bending operation by using an object on a screen of the touch panel 54. The object is a finger, a stylus, or the like.

The operation button 55 receives various instructions from a user. The user can input an instruction associated with power supply or illumination to the endoscope system 1 by pressing the operation button 55. The speaker 56 outputs a warning sound, a voice message, and the like. The communication unit 57 includes a communication circuit and executes wired communication or wireless communication for bending control or the like with the base unit 4. The communication unit 58 includes a communication circuit and executes wireless communication with the external device 7.

An image generated by the imaging unit 20 is processed by the image-processing unit 31 and is output to the control unit 40. The control unit 40 outputs the image to the communication unit 42, and the communication unit 42 transmits the image to the communication unit 57. The communication unit 57 receives the image and outputs the image to the control unit 50. The control unit 50 output the image to the display 53 and displays the image on the display 53. The imaging unit 20 sequentially generates an image, and the control unit 50 sequentially updates the image displayed on the display 53.

When a user performs a bending operation on the screen of the touch panel 54, the touch panel 54 outputs information input in the bending operation to the control unit 50. The control unit 50 calculates a bending control value for bending the insertion unit 2 in accordance with the information. The control unit 50 outputs the bending control value to the communication unit 57. The communication unit 57 transmits the bending control value to the communication unit 42. The communication unit 42 receives the bending control value and outputs the bending control value to the control unit 40. The control unit 40 outputs the bending control value to the bending control unit 34.

The bending control unit 34 outputs a bending control value in a UD direction to the UD drive unit 32 and outputs a bending control value in an RL direction to the RL drive unit 33. The UD drive unit 32 bends the bending portion 21 in a U direction or a D direction by pulling a UD bending wire based on the bending control value in the UD direction. Accordingly, the insertion unit 2 is bent in the U direction or the D direction. The RL drive unit 33 bends the bending portion 21 in an R direction or an L direction by pulling an RL bending wire based on the bending control value in the RL direction. Accordingly, the insertion unit 2 is bent in the R direction or the L direction.

The external device 7 is a portable small terminal. The external device 7 can be stored in a storage portion (a holder) of the main unit 5.

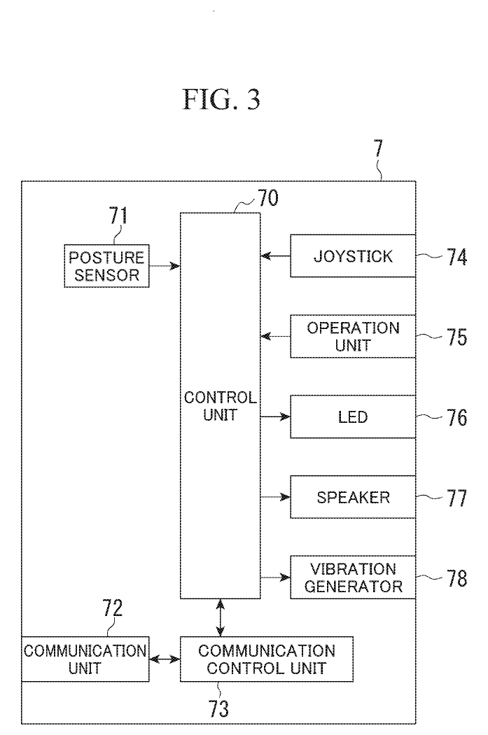

FIG. 3 shows an example of the configuration of the external device 7. The external device 7 includes a control unit 70, a posture sensor 71, a communication unit 72, a communication control unit 73, a joystick 74, an operation unit 75, an LED 76, a speaker 77, and a vibration generator 78.

The control unit 70 controls each unit of the external device 7. The control unit 70 may be constituted by at least one of a processor and a logic circuit. The control unit 70 may include one or more processors. The control unit 70 may include one or more logic circuits. A computer of the endoscope system 1 may read a program and execute the read program. The program includes instructions for defining operations of the control unit 70. That is, the function of the control unit 70 may be realized by software. The program for realizing the function of the control unit 70 may be realized similarly to the program for realizing the function of the control unit 40 or the like.

For example, the posture sensor 71 is a combination of an acceleration sensor and a gyro sensor. The posture sensor 71 determines the gravitational direction and determines the posture of the external device 7 with respect to the gravitational direction. The posture sensor 71 determines the motion state of the external device 7.

The communication unit 72 includes a communication circuit and executes wireless communication with the main unit 5. The communication control unit 73 controls the wireless communication executed by the communication unit 72.

The joystick 74 is a rod-shaped movable member and serves as a physical user interface. A user comes into contact with the joystick 74 with a finger or the like and applies a force to the joystick 74. Accordingly, the user can tilt the joystick 74 in the U direction, the D direction, the L direction, or the R direction. The joystick 74 outputs a signal based on a direction in which the joystick 74 is tilted and an angle by which the joystick 74 is tilted.

The operation unit 75 includes buttons for receiving various instructions from a user. The LED 76 generates light for warning or the like. The speaker 77 outputs a warning sound or the like. The vibration generator 78 includes a motor or the like for generating vibration for warning or the like.

When a user performs a bending operation by operating the joystick 74, the joystick 74 outputs a signal input through the bending operation to the control unit 70. The control unit 70 calculates a bending control value for bending the insertion unit 2 in accordance with the signal. The control unit 70 outputs the bending control value to the communication control unit 73. The communication control unit 73 controls the communication unit 72 such that the bending control value is transmitted to the communication unit 58. The communication unit 58 receives the bending control value and outputs the bending control value to the control unit 50. Thereafter, similar operations to those described above are executed, and the endoscope system 1 bends the insertion unit 2.

The distal end portion 2a may include a temperature sensor. The scope unit 3, the base unit 4, or the main unit 5 may include a temperature sensor. The external device 7 may include a temperature sensor.

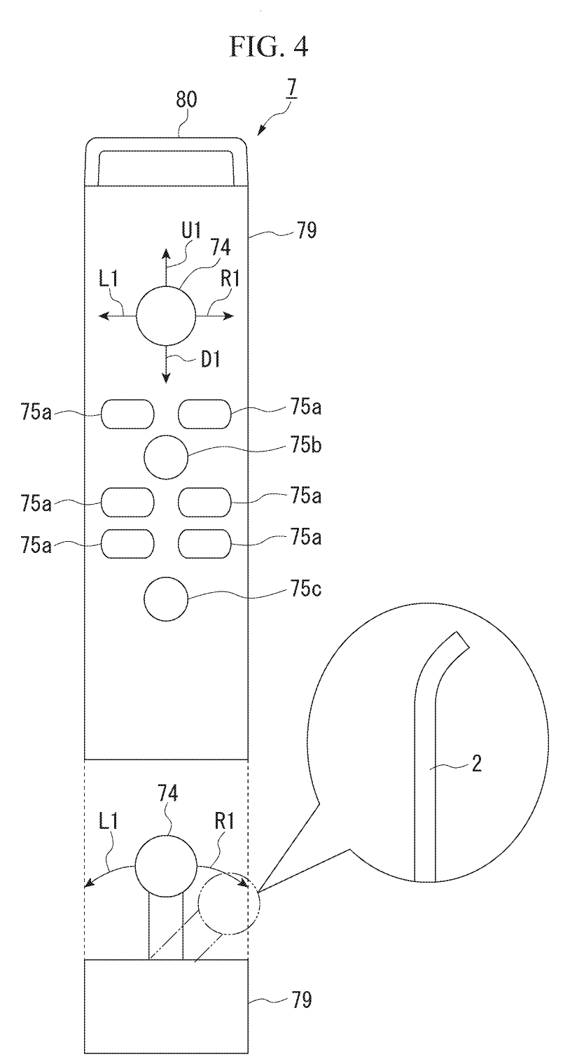

FIG. 4 is a front view and a side view showing the appearance of the external device 7. The external device 7 shown in FIG. 4 has a thin and long shape. The shape of the external device 7 is not limited to the example shown in FIG. 4.

The external device 7 includes a housing 79. The joystick 74 is disposed on the housing 79. When a user is not operating the joystick 74, the joystick 74 is almost perpendicular to the surface of the external device 7. The control unit 70, the posture sensor 71, the communication unit 72, the communication control unit 73, the LED 76, the speaker 77, and the vibration generator 78 shown in FIG. 3 are disposed in the housing 79. A component 80 for storing the external device 7 in the storage portion of the main unit 5 is disposed in the upper portion of the housing 79.

The user tilts the joystick 74 in an upward direction U1, a downward direction D1, a leftward direction L1, or a rightward direction R1. At this time, the joystick 74 outputs a signal based on a direction in which the joystick 74 is tilted and an angle by which the joystick 74 is tilted.

When the user tilts the joystick 74 in the upward direction U1, the insertion unit 2 is bent upward. When the user tilts the joystick 74 in the downward direction D1, the insertion unit 2 is bent downward. When the user tilts the joystick 74 in the leftward direction L1, the insertion unit 2 is bent leftward. When the user tilts the joystick 74 in the rightward direction R1, the insertion unit 2 is bent rightward.

The user can relatively easily adjust the angle of the joystick 74. Accordingly, the user can finely adjust the amount of bending of the insertion unit 2. In the following description, an operation in which the user tilts the joystick 74 is referred to as a joystick operation.

The posture sensor 71 is fixed to the housing 79. The posture sensor 71 can determine a rotation direction and the amount of rotation of the housing 79 around three axes that are perpendicular to each other. The user may tilt the external device 7 in a predetermined direction in order to perform a bending operation. The posture sensor 71 may determine a rotation direction and the amount of rotation of the housing 79 in accordance with the motion of the external device 7. The endoscope system 1 may bend the insertion unit 2 in accordance with the rotation direction and the amount of rotation of the housing 79. The user can intuitively bend the insertion unit 2 by tilting the external device 7. In the following description, an operation in which the user tilts the external device 7 is referred to as a tilting operation.

Two or more buttons 75a, a joystick 75b, and a power button 75c are disposed on the housing 79. These are included in the operation unit 75.

The two or more buttons 75a include a button for executing centering for straightening the insertion unit 2 that has been bent. The joystick 75b is used to move a pointer (a cursor) displayed on the screen of the display 53. The joystick 75b is used to operate a menu at a position at which the pointer is displayed. The power button 75c is used to turn on or off a power supply of the external device 7.

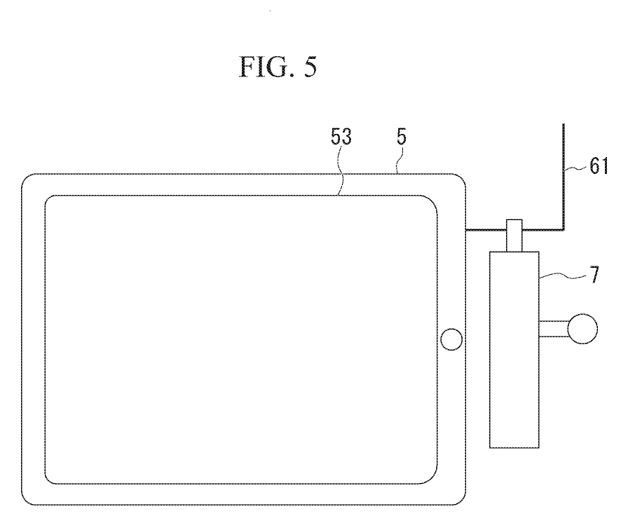

FIG. 5 shows an example of a state in which the external device 7 is stored in the main unit 5 while the endoscope system 1 is operating. The main unit 5 includes a storage portion 61. For example, the storage portion 61 is a hook and is disposed on the side surface of the main unit 5. The external device 7 is stored in the storage portion 61 by hooking the component 80 of the external device 7 to the storage portion 61. When the external device 7 is stored in the storage portion 61, the longitudinal direction of the external device 7 is parallel to the gravitational direction, and the external device 7 is stationary. A user detaches the external device 7 from the storage portion 61 to operate the external device 7 and grasps the external device 7 with a hand. When the user temporarily stops using the external device 7 in inspection, the user may store the external device 7 in the storage portion 61.

A method of storing the external device 7 in the main unit 5 is not limited to the aforementioned method. The storage portion 61 may be a container, a case, a box, or the like. A fixing tool for fixing the external device 7 to the main unit 5 may be used. The scope unit 3 or the base unit 4 may include a storage portion.

The control unit 70 can determine whether the external device 7 is stored in the storage portion 61 based on the posture of the external device 7 determined by the posture sensor 71. A method of determining a storage state of the external device 7 is not limited to this method.

The main unit 5 may include a sensor that determines the motion of the storage portion 61 or a weight added to the storage portion 61. The sensor may be a mechanical sensor or an optical sensor. The control unit 50 may determine whether the external device 7 is stored in the storage portion 61 based on the motion or weight.

The control unit 50 may measure the intensity of radio waves received by the communication unit 58 and determine whether the external device 7 is located at a position close to the main unit 5 based on the intensity. The control unit 50 may determine whether the external device 7 is located at a position close to the main unit 5 by using infrared, short-range wireless communication, or the like.

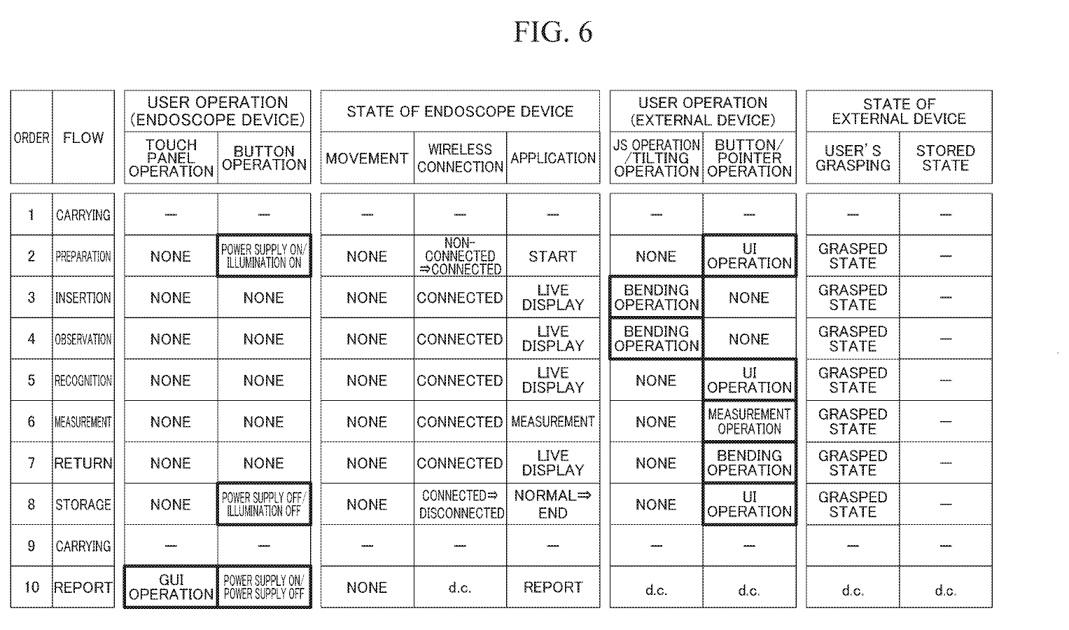

FIG. 6 shows a first example of an inspection flow and device states. The inspection flow indicates a flow of inspection using the endoscope system 1. In the first example, a user performs principal operations in inspection using the external device 7.

For example the inspection flow includes 10 basic steps. An inspection scene in each step is represented as a combination of the type of operation of the endoscope device 10 performed by the user, a state of the endoscope device 10, the type of operation of the external device 7 performed by the user, and a state of the external device 7.

The operation of the endoscope device 10 performed by the user includes an operation of the touch panel 54 and an operation of the operation button 41 or the operation button 55. The state of the endoscope device 10 includes a moving state of the main unit 5, a state of wireless connection between the main unit 5 and the external device 7, and a state of an endoscope application operating in the main unit 5.

The operation of the external device 7 performed by the user includes the joystick operation or the tilting operation for performing a bending operation. The operation of the external device 7 performed by the user includes an operation of the joystick 75b or the power button 75c. The operation of the joystick 75b is an operation of the pointer displayed on the screen of the display 53. The state of the external device 7 includes a state indicating whether the user is grasping the external device 7 and a state indicating whether the external device 7 is stored in the storage portion 61 of the main unit 5.

Steps of each inspection flow will be described below.

### Carrying step

A first step is a carrying step. In the carrying step, a user goes to a place at which the endoscope system 1 enclosed in a carrying case is stored (for example, storehouse) and carries the carrying case from the place to an inspection site.

### Preparation step

A second step is a preparation step. The preparation step is performed in an inspection site. The user takes out the endoscope device 10 and the external device 7 from the carrying case. The user performs setup to make the endoscope system 1 in a usable state.

For example, the user turns on power supplies of the scope unit 3, the base unit 4, the main unit 5, and the external device 7 and turns on the light source 35 by operating the operation button 41 of the base unit 4, the operation button 55 of the main unit 5, and the power button 75c of the external device 7. The light source 35 is an illumination. The operation of the power button 75c of the external device 7 in the preparation step is shown as a user interface (UI) operation in FIG. 6.

The user takes out the external device 7 from the storage portion 61 of the main unit 5 and grasps the external device 7 with a hand. The user starts an endoscope application by operating the joystick 75b. When the endoscope application starts, the communication unit 58 and the communication unit 72 start wireless connection.

### Insertion step

A third step is an insertion step. The user inserts the insertion unit 2 into a subject and causes the insertion unit 2 to reach an inspection position in the subject. The endoscope application operates in a live display mode and displays an image generated by the imaging unit 20 on the display 53. Until the insertion unit 2 reaches the inspection position, the user performs the joystick operation or the tilting operation in the external device 7 while viewing the image displayed on the display 53. That is, the user performs a bending operation. In general, the user performs a bending operation for greatly bending the insertion unit 2.

### Observation step

A fourth step is an observation step. After the insertion unit 2 has reached the inspection position, the user performs the joystick operation or the tilting operation in the external device 7 while viewing the image displayed on the display 53. That is, the user performs the bending operation. In general, the user performs a bending operation for finely bending the insertion unit 2. The user causes the distal end portion 2a to reach a position appropriate for observation of the subject. The user observes the image displayed on the display 53 and checks whether an abnormal part is present in the subject.

### Recognition step

A fifth step is a recognition step. When an abnormal region or a region with a likelihood of an abnormal region has been found, the user inputs an instruction to record the image by operating the joystick 75b. The joystick 75b outputs the instruction to the control unit 70. The control unit 70 outputs the instruction to the communication control unit 73. The communication control unit 73 controls the communication unit 72 such that the instruction is transmitted to the communication unit 58.

The communication unit 58 receives the instruction and outputs the instruction to the control unit 50. The control unit 50 records the image generated by the imaging unit 20 on the nonvolatile memory 60 in accordance with the instruction. For example, a still image is recorded on the nonvolatile memory 60. The operation of the joystick 75b in the recognition step is shown as a UI operation in FIG. 6.

### Measurement step

A sixth step is a measurement step. The user inputs an instruction associated with measurement by operating the joystick 75b. For example, the instruction indicates one or more measurement positions in the image displayed on the display 53. A similar operation to that described above is executed, and the instruction is output to the control unit 50. The control unit 50 executes measurement in accordance with the instruction and measures the length, the depth, or the like of a damaged region or the like appearing in the image. The endoscope application operates in a measurement mode. The user performs detailed determination of an abnormal region based on a measured value. The operation of the joystick 75b in the measurement step is shown as a measurement operation in FIG. 6.

The insertion step, the observation step, the recognition step, the measurement step, and a return step are repeated according to necessity.

### Return step

A seventh step is a return step. After inspection has ended, the user returns the insertion unit 2 from the inside of the subject. In general, the user operates the button 75a and inputs an instruction to execute centering. The button 75a outputs the instruction to the control unit 70. A similar operation to that described above is executed, and the instruction is output to the control unit 50. The control unit 50 outputs the instruction to the communication unit 57. The communication unit 57 transmits the instruction to the communication unit 42.

The communication unit 42 receives the instruction and outputs the instruction to the control unit 40. The control unit 40 outputs the instruction to the bending control unit 34. The bending control unit 34 executes centering in accordance with the instruction. The endoscope application operates in the live display mode. The operation of the button 75a in the return step is shown as a bending operation in FIG. 6.

### Storage step

An eighth step is a storage step. After the distal end portion 2a has been returned to the outside of the subject, the user inputs an instruction to end the endoscope application by operating the joystick 75b. The joystick 75b outputs the instruction to the control unit 70. A similar operation to that described above is executed, and the instruction is output to the control unit 50. The control unit 50 ends the endoscope application. When the instruction to end the endoscope application is input, the power supply of the external device 7 is automatically turned off. The operation of the joystick 75b in the storage step is shown as a UI operation in FIG. 6.

The user turns off the power supplies of the scope unit 3, the base unit 4, and the main unit 5 and turns off the light source 35 by operating the operation button 41 of the base unit 4 and the operation button 55 of the main unit 5. The communication unit 58 and the communication unit 72 end wireless connection. The user stores the endoscope device 10 and the external device 7 in the carrying case.

### Carrying step

A ninth step is a carrying step. The user carries the carrying case from the inspection site to an office.

### Report step

A tenth step is a report step. The user takes out the endoscope device 10 from the carrying case. The user performs setup to make the endoscope system 1 usable. The user starts the endoscope application by operating the touch panel 54.

The user prepares an inspection report by using a report function of the endoscope application. The endoscope application operates in a report mode. The operation of the touch panel 54 in the report step is shown as a graphical user interface (GUI) operation in FIG. 6. After preparation of an inspection report has ended, the user turns off the power supplies of the scope unit 3, the base unit 4, and the main unit 5.

In FIG. 6 and other drawings, “d.c.” indicates an arbitrary state.

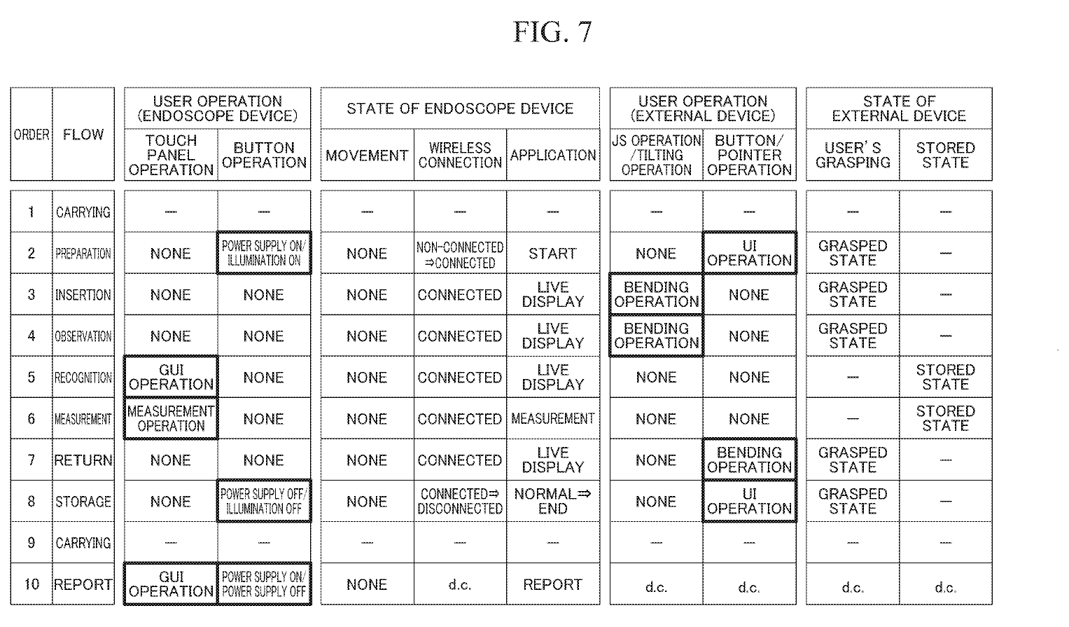

FIG. 7 shows a second example of the inspection flow and the device states. The same parts as those shown in FIG. 6 will not be described.

In the insertion step, the observation step, and the return step, the user operates the external device 7. On the other hand, in the recognition step and the measurement step, the user operates the touch panel 54.

In the observation step, after the distal end portion 2a has reached the position appropriate for observation of the subject, the user stores the external device 7 in the storage portion 61. In the recognition step and the measurement step, the external device 7 is stored in the storage portion 61.

When an abnormal region or a region with a likelihood of an abnormal region has been found, the user inputs an instruction to record an image by operating the touch panel 54. The touch panel 54 outputs the instruction to the control unit 50. The control unit 50 records the image generated by the imaging unit 20 on the nonvolatile memory 60 in accordance with the instruction. The operation of the touch panel 54 in the recognition step is shown as a GUI operation in FIG. 7.

The user inputs an instruction associated with measurement by operating the touch panel 54. The touch panel 54 outputs the instruction to the control unit 50. The control unit 50 executes measurement in accordance with the instruction and measures the length, the depth, or the like of a damaged region or the like appearing in the image. The operation of the touch panel 54 in the measurement step is shown as a measurement operation in FIG. 7.

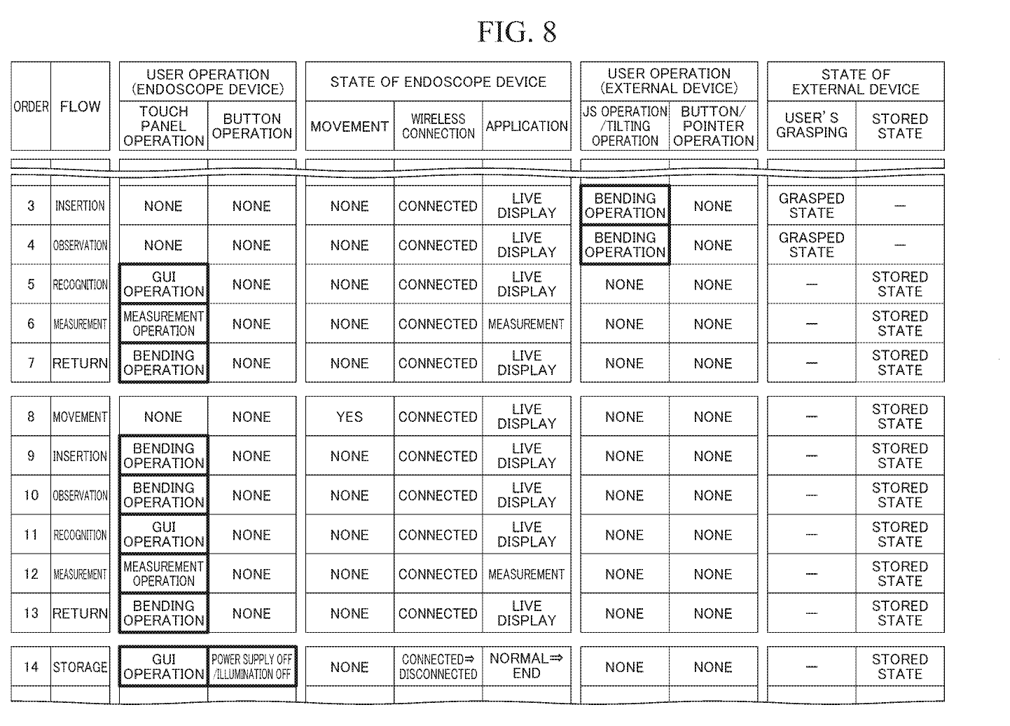

FIG. 8 shows a third example of the inspection flow and the device states. The same parts as those shown in FIGS. 6 or 7 will not be described. The inspection flow shown in FIG. 8 includes a moving step in addition to the aforementioned 10 basic steps. The inspection flow shown in FIG. 8 includes the carrying step, the preparation step, and the report step, which are not shown in FIG. 8.

The insertion unit 2 is inserted into the subject via an inspection port (an access port). The inspection port is a hole included in the subject to insert the insertion unit 2 into the subject. After the inspection has ended, the user returns the insertion unit 2 from the inside of the subject. At this time, the user operates the touch panel 54 and inputs an instruction to execute centering. The touch panel 54 outputs the instruction to the control unit 50. A similar operation to that described above is executed, and the instruction is output to the control unit 40.

The control unit 40 outputs the instruction to the bending control unit 34. The bending control unit 34 executes centering in accordance with the instruction. The endoscope application operates in the live display mode. The operation of the touch panel 54 in the return step is shown as a bending operation in FIG. 8.

After the insertion unit 2 has been returned from the inspection port, the user moves the endoscope device 10 to a place close to another inspection port. This is a moving step.

Thereafter, in the insertion step, the user inserts the insertion unit 2 into the subject and causes the insertion unit 2 to reach the inspection position in the subject. The external device 7 is stored in the storage portion 61. The user operates the touch panel 54. The user performs a bending operation on the touch panel 54 while viewing the image displayed on the display 53.

After the insertion step, the observation step is executed. The user performs the bending operation on the touch panel 54 while viewing the image displayed on the display 53. The user causes the distal end portion 2a to reach a position appropriate for observation of the subject. The user observes the image displayed on the display 53 and checks whether an abnormal region is included in the subject.

After the observation step, the recognition step, the measurement step, and the return step are executed. In these steps, the user operates the touch panel 54.

In the storage step, the user inputs an instruction to end the endoscope application by operating the touch panel 54. The touch panel 54 outputs the instruction to the control unit 50. The control unit 50 ends the endoscope application. When the instruction to end the endoscope application is input, the power supply of the main unit 5 is automatically turned off.

The user turns off the power supplies of the scope unit 3 and the base unit 4 and turns off the light source 35 by operating the operation button 41 of the base unit 4 and the operation button 55 of the main unit 5. The communication unit 58 and the communication unit 72 end wireless connection. The user stores the endoscope device 10 and the external device 7 in the carrying case.

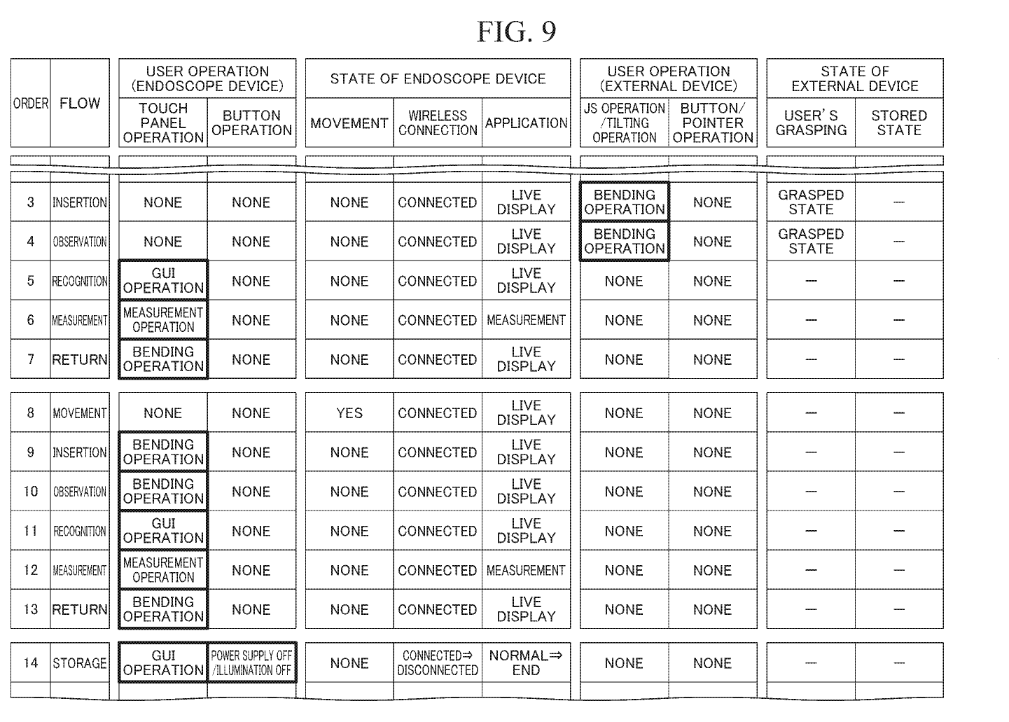

FIG. 9 shows a fourth example of the inspection flow and the device states. The same parts as those shown in FIG. 8 will not be described. The inspection flow shown in FIG. 9 includes a carrying step, a preparation step, and a report step, which are not shown in FIG. 9.

In the insertion step and the observation step, the user operates the external device 7. In the insertion step and the observation step, after the distal end portion 2a has reached the position appropriate for observation of the subject, the user does not store the external device 7 in the storage portion 61 and puts the external device 7, for example, on a table. In the recognition step, the user inputs an instruction to record an image by operating the touch panel 54.

After the recognition step, the measurement step and the return step are executed. In these steps, the user operates the touch panel 54. After the insertion unit 2 has been returned from the inspection port in the return step, the user moves the endoscope device 10 in the moving step.

After the moving step, the insertion step, the observation step, the recognition step, the measurement step, and the return step are executed. In these steps, the user operates the touch panel 54. While the user is operating the touch panel 54, there is a likelihood that the user will forget a position at which the external device 7 is placed.

Since the inspection site is dark in the nighttime inspection, it may be difficult for the user to ascertain the position at which the external device 7 is placed. Since the user performs inspection while moving in an inspection site in which inspection of an aircraft engine or the like is performed, there is a likelihood that the user will forget the position at which the external device 7 is placed. Even when the user performs inspection in an uncomfortable posture, it may be difficult for the user to ascertain a position at which the external device 7 is placed.

When the storage step is performed in this situation, the user in the fourth example shown in FIG. 9 wants to store the external device 7, but cannot find the external device 7.

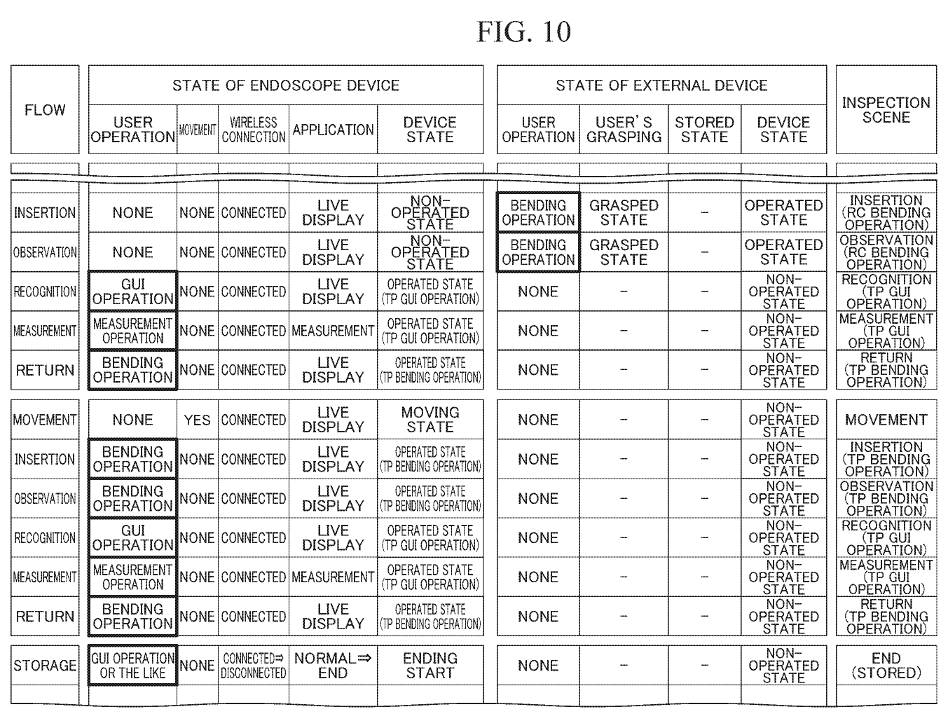

FIG. 10 shows an example of the device states and the external device 7 in the fourth example shown in FIG. 9. The state of the endoscope device 10, the state of the external device 7, and the inspection scene in each step of the inspection flow are shown.

The state of the endoscope device 10 includes a state of an operation performed in the base unit 4 or the main unit 5, a moving state of the main unit 5, a state of wireless connection between the main unit 5 and the external device 7, a state of an endoscope application, and a device state. The device state of the endoscope device 10 indicates an execution state of inspection of the endoscope device 10 that is comprehensively determined from the state of the operation performed in the base unit 4 or the main unit 5, the moving state of the main unit 5, the state of the wireless connection between the main unit 5 and the external device 7, and the state of the endoscope application.

The state of the external device 7 includes a state of an operation performed in the external device 7, a state associated with the user’s grasping the external device 7, a storage state of the external device 7 in the storage portion 61, and a device state. The device state of the external device 7 indicates an execution state of inspection of the external device 7 that is comprehensively determined from the state of the operation performed in the external device 7, the state associated with the user’s grasping the external device 7, and the storage state of the external device 7 in the storage portion 61.

The inspection scene indicates an inspection state corresponding to the state of the endoscope device 10 and the state of the external device 7.

In the insertion step, the user does not operate the operation button 41, the operation button 55, or the touch panel 54. The device state of the endoscope device 10 in the insertion step is a non-operated state. In the insertion step, the user performs the bending operation by using the joystick 74. The device state of the external device 7 in the insertion step is an operated state. The inspection scene in the insertion step is “insertion” accompanying the bending operation (RC bending operation) in the external device 7. RC indicates the external device 7 which is a remote controller.

In the observation step, the user does not operate the operation button 41, the operation button 55, or the touch panel 54. The device state of the endoscope device 10 in the observation step is a non-operated state. In the observation step, the user performs the bending operation by using the joystick 74. The device state of the external device 7 in the observation step is an operated state. The inspection scene in the observation step is “observation” accompanying the bending operation (RC bending operation) in the external device 7.

In the recognition step, the user inputs an instruction to record an image by operating the touch panel 54. The device state of the endoscope device 10 in the recognition step is an operated state. In the recognition step, the user does not operate the external device 7. At this time, the external device 7 is not stored in the storage portion 61 and is placed, for example, on a table. The device state of the external device 7 in the recognition step is a non-operated state. The inspection scene in the recognition step is “recognition” accompanying the operation of the touch panel 54 (TP GUI operation) in the endoscope device 10. TP indicates a touch panel.

In the measurement step, the user inputs an instruction associated with measurement by operating the touch panel 54. The device state of the endoscope device 10 in the measurement step is an operated state. In the measurement step, the user does not operate the external device 7. The device state of the external device 7 in the measurement step is a non-operated state. The inspection scene in the measurement step is “measurement” accompanying the operation of the touch panel 54 (TP GUI operation) in the endoscope device 10.

In the return step, the user inputs an instruction to execute centering by operating the touch panel 54. The device state of the endoscope device 10 in the return step is an operated state. In the return step, the user does not operate the external device 7. The device state of the external device 7 in the return step is a non-operated state. The inspection scene in the return step is “return” accompanying the bending operation (TP bending operation) in the touch panel 54.

In the moving step, the user moves the endoscope device 10. The device state of the endoscope device 10 in the moving step is a moving state. In the moving step, the user does not operate the external device 7. The device state of the external device 7 in the moving step is a non-operated state. The inspection scene in the moving step is “moving.”

In the insertion step that is executed again, the user performs the bending operation in the touch panel 54. The device state of the endoscope device 10 in the insertion step is an operated state. In the insertion step, the user does not operate the external device 7. The device state of the external device 7 in the insertion step is a non-operated state. The inspection scene in the insertion step is “insertion” accompanying the bending operation (TP bending operation) in the touch panel 54.

In the observation step that is executed again, the user performs the bending operation on the touch panel 54. The device state of the endoscope device 10 in the observation step is an operated state. In the observation step, the user does not operate the external device 7. The device state of the external device 7 in the observation step is a non-operated state. The inspection scene in the observation step is “observation” accompanying the bending operation (TP bending operation) in the touch panel 54.

Thereafter, the recognition step, the measurement step, and the return step are executed. The device states and the inspection scenes in the steps are the same as the device state and the inspection scenes described above.

In the storage step, the user inputs an instruction to end the endoscope application by operating the touch panel 54. The user turns off the power supplies of the scope unit 3 and the base unit 4 and turns off the light source 35 by operating the operation button 41 of the base unit 4 and the operation button 55 of the main unit 5.

The device state of the endoscope device 10 in the storage step is an ending start state. The ending start state indicates a state in which ending of the endoscope application has started. In the storage step, the user does not operate the external device 7. The device state of the external device 7 in the storage step is a non-operated state. The inspection scene in the storage step is “end (stored).”

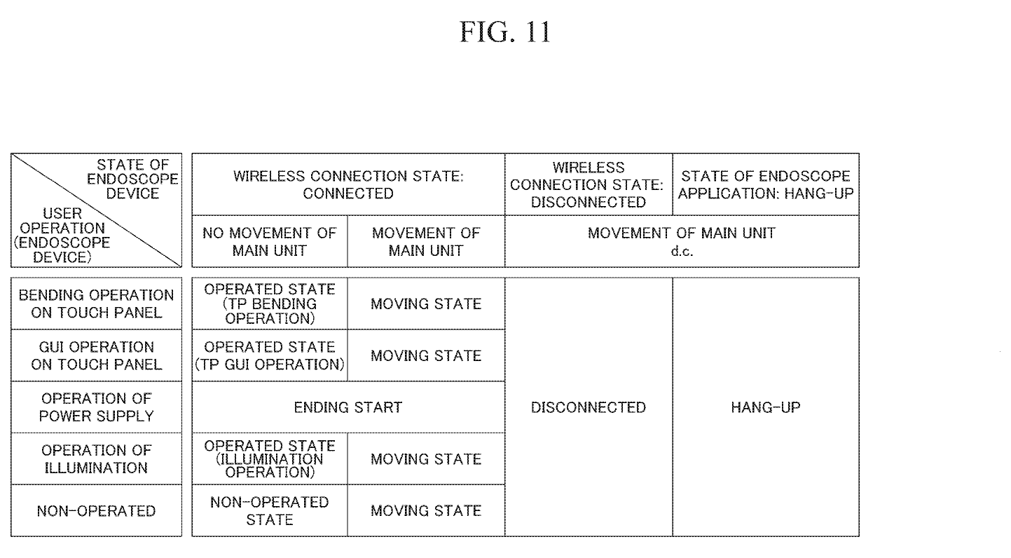

FIG. 11 shows an example of the device state of the endoscope device 10. When wireless connection between the main unit 5 and the external device 7 is maintained, the device state of the endoscope device 10 is a state based on the operation of the operation button 41, the operation button 55 or the touch panel 54 and the moving state of the main unit 5. When the wireless connection is cut off for some reasons, the device state of the endoscope device 10 is “disconnected.” When the endoscope application hangs up, the device state of the endoscope device 10 is “hang-up.”

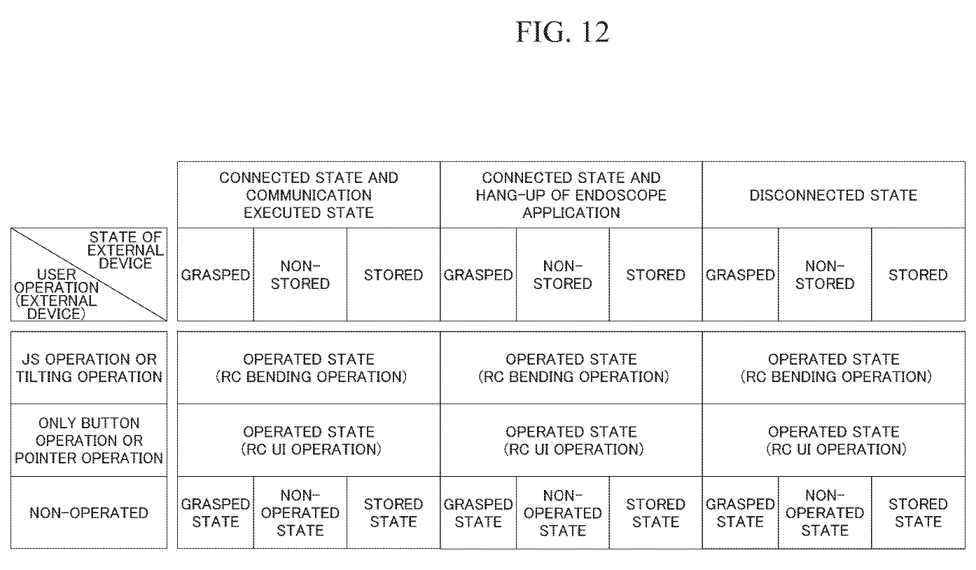

FIG. 12 shows an example of the device state of the external device 7. The device state of the external device 7 is a state based on the operation of the external device 7 performed by the user and various states of the external device 7. A combination of the state of the wireless connection and the state of the endoscope application is one of the following three combinations.
(1) Wireless connection is maintained, and the endoscope application executes communication.
(2) Wireless connection is maintained, and the endoscope application hangs up.
(3) Wireless connection is cut off.

The following device states are applied to any of the three combinations. When the user is performing the joystick operation or the tilting operation, the device state of the external device 7 is an operation state in which the bending operation (RC bending operation) is performed. When the user is operating the button 75a or the joystick 75b, the device state of the external device 7 is an operation state corresponding to the operation (RC UI operation).

When the user is grasping the external device 7 and is not operating the external device 7, the device state of the external device 7 is a grasped state. When the user is grasping the external device 7, the external device 7 is not stationary. When information generated by the posture sensor 71 indicates that the external device 7 is moving, it can be determined that the user is grasping the external device 7.

When the external device 7 is not stored in the storage portion 61 and the user is not operating the external device 7, the device state of the external device 7 is a non-operated state. When information generated by the posture sensor 71 indicates that the longitudinal direction of the external device 7 is not parallel to the gravitational direction and the external device 7 is stationary, it can be determined that the external device 7 is not stored in the storage portion 61. The non-operated state in this specification refers to a state in which the external device 7 is not stored in the storage portion 61 and the user is not operating the external device 7. When the external device 7 is stored in the storage portion 61, the device state of the external device 7 is a stored state.

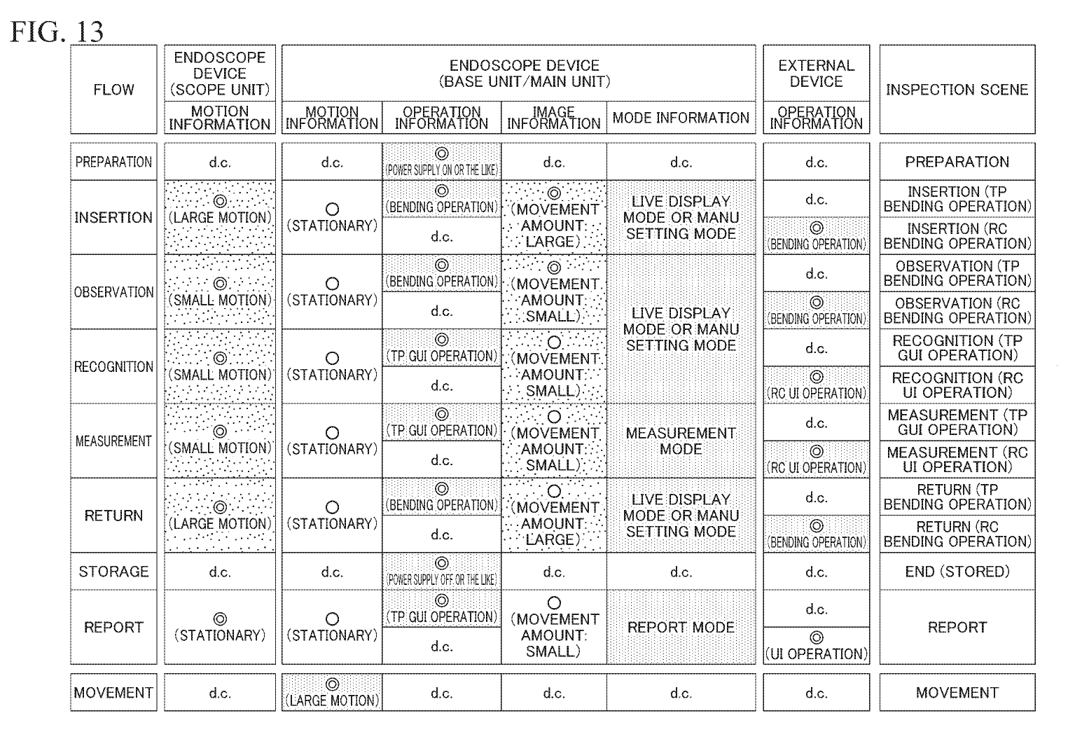

FIG. 13 shows an example of a relationship between information acquired in the endoscope device 10 and the external device 7 and the inspection scenes. The inspection scenes in the steps of the inspection flow are shown, and the inspection scene in the carrying step is not necessary and is not shown in FIG. 13.

Motion information, operation information, image information, and mode information are acquired by the endoscope device 10. The motion information refers to information determined by the posture sensor 52 of the main unit 5. When a similar posture sensor to the posture sensor 52 is included in the distal end portion 2a of the insertion unit 2, the motion information indicates the motion determined by the posture sensor of the distal end portion 2a. The operation information indicates the operation of the operation button 41, the operation button 55, or the touch panel 54. The image information indicates the amount of movement of an object in the image generated by the imaging unit 20. The image-processing unit 31 executes image processing and calculates the amount of movement of an object between two images generated at different times. The mode information indicates a mode of the endoscope application.

The operation information is acquired by the external device 7. The operation information indicates the operation of the joystick 74 or the operation unit 75.

The control unit 40 or the control unit 50 of the endoscope device 10 or the control unit 70 of the external device 7 can determine the inspection scene based on information acquired in at least one of the endoscope device 10 and the external device 7. Information indicated by hatched areas in FIG. 13 is required for determining the inspection scene. Information indicated by dotted areas in FIG. 13 is not required for determining the inspection scene, but the estimation accuracy of the inspection scene can be increased by using the information.

In the preparation step, the operation button 41 and the operation button 55 are operated to turn on the power supplies of the scope unit 3, the base unit 4, and the main unit 5. When operation information indicating the operations of the operation button 41 and the operation button 55 is generated, the inspection scene is “preparation.”

When the user performs the bending operation in the touch panel 54 in the insertion step, operation information indicating the bending operation in the touch panel 54 is generated. When the user performs the joystick operation or the tiling operation in the external device 7 in the insertion step, operation information indicating the bending operation in the external device 7 is generated. The mode of the endoscope application is a live display mode or a menu setting mode. The user can switch the endoscope application mode between the live display mode and the menu setting mode.

When the operation information indicating the bending operation in the touch panel 54 is generated and the mode of the endoscope application is the live display mode or the menu setting mode, the inspection scene is “insertion” accompanying the bending operation (TP bending operation) in the touch panel 54. When operation information indicating the bending operation is generated in accordance with the joystick operation or the tilting operation and the mode of the endoscope application is the live display mode or the menu setting mode, the inspection scene is “insertion” accompanying the bending operation (RC bending operation) in the external device 7.

In order to determine the inspection scene in the insertion step, image information may be used in addition to the operation information or the like. When the amount of movement in a direction in which the insertion unit 2 is inserted is large, the accuracy of the determination result for the inspection scene “insertion” is improved. Motion information generated by the posture sensor of the distal end portion 2a may be used. When the motion information indicating a large motion, the accuracy of the determination result for the inspection scene “insertion” is improved.

In the observation step, the same information as that generated in the insertion step is generated. When operation information indicating the bending operation in the touch panel 54 is generated and the mode of the endoscope application is the live display mode or the menu setting mode, the inspection scene is “observation” accompanying the bending operation (TP bending operation) in the touch panel 54. When operation information indicating the bending operation is generated in accordance with the joystick operation or the tilting operation and the mode of the endoscope application is the live display mode or the menu setting mode, the inspection scene is “observation” accompanying the bending operation (RC bending operation) in the external device 7.

When the amount of bending in the bending operation is large, the control unit 40 or the control unit 50 of the endoscope device 10 or the control unit 70 of the external device 7 may determine that the inspection scene is “insertion.” When the amount of bending in the bending operation is small, the control unit 40 or the control unit 50 of the endoscope device 10 or the control unit 70 of the external device 7 may determine that the inspection scene is “observation.”

In order to determine the inspection scene in the observation step, image information may be used in addition to the operation information or the like. When the amount of movement calculated based on an image is small, the accuracy of the determination result for the inspection scene “observation” is improved. Motion information generated by the posture sensor of the distal end portion 2a may be used. When the motion information indicates a small motion, the accuracy of the determination result for the inspection scene “observation” is improved.

In the recognition step, the user inputs an instruction to record an image by operating the touch panel 54. Alternatively, the user inputs the instruction by operating the joystick 75b. The mode of the endoscope application is the live display mode or the menu setting mode.

When operation information indicating the operation of the touch panel 54 is generated and the mode of the endoscope application is the live display mode or the menu setting mode, the inspection scene is “recognition” accompanying the operation (TP GUI operation) of the touch panel 54. When operation information indicating the operation in the joystick 75b is generated and the mode of the endoscope application is the live display mode or the menu setting mode, the inspection scene is “recognition” accompanying the bending operation (RC UI operation) in the external device 7.

In order to determine the inspection scene in the recognition step, image information may be used in addition to the operation information or the like. When the amount of movement calculated based on an image is small, the accuracy of the determination result for the inspection scene “recognition” is improved. Motion information generated by the posture sensor of the distal end portion 2a may be used. When the motion information indicates a small motion, the accuracy of the determination result for the inspection scene “recognition” is improved.

In the measurement step, the user inputs an instruction associated with measurement by operating the touch panel 54. Alternatively, the user inputs the instruction by operating the joystick 75b. The mode of the endoscope application is a measurement mode.

When operation information indicating the operation of the touch panel 54 is generated and the mode of the endoscope application is the measurement mode, the inspection scene is “measurement” accompanying the operation (TP GUI operation) of the touch panel 54. When operation information indicating the operation in the joystick 75b is generated and the mode of the endoscope application is the measurement mode, the inspection scene is “measurement” accompanying the bending operation (RC UI operation) in the external device 7.

In order to determine the inspection scene in the measurement step, image information may be used in addition to the operation information or the like. When the amount of movement calculated based on an image is small, the accuracy of the determination result for the inspection scene “measurement” is improved. Motion information generated by the posture sensor of the distal end portion 2a may be used. When the motion information indicates a small motion, the accuracy of the determination result for the inspection scene “measurement” is improved.

In the return step, the same information as that generated in the insertion step is generated. When operation information indicating the bending operation in the touch panel 54 is generated and the mode of the endoscope application is the live display mode or the menu setting mode, the inspection scene is “return” accompanying the bending operation (TP bending operation) in the touch panel 54. When the operation information indicating the bending operation is generated in accordance with the joystick operation or the tilting operation and the mode of the endoscope application is the live display mode or the menu setting mode, the inspection scene is “return” accompanying the bending operation (RC bending operation) in the external device 7.

In order to determine the inspection scene in the return step, image information may be used in addition to the operation information or the like. When the amount of movement in the direction in which the insertion unit 2 is pulled out is large, the accuracy of the determination result for the inspection scene “return” is improved. Motion information generated by the posture sensor of the distal end portion 2a may be used. When the motion information indicates a large motion, the accuracy of the determination result for the inspection scene “return” is improved.

In the storage step, the user turns off the power supplies of the scope unit 3, the base unit 4, and the main unit 5 and turns off the light source 35 by operating the operation button 41 and the operation button 55. When operation information indicating the operations of the operation button 41 and the operation button 55 is generated, the inspection scene is “end (stored).”

In the report step, the user operates the touch panel 54 and prepares an inspection report. The mode of the endoscope application is a report mode. When operation information indicating the bending operation in the touch panel 54 is generated and the mode of the endoscope application is the report mode, the inspection scene is “report.”

In order to determine the inspection scene in the report step, motion information generated by the posture sensor of the distal end portion 2a may be used in addition to the operation information or the like. When the motion information indicates a stationary state of the distal end portion 2a, the accuracy of the determination result for the inspection scene “report” is improved.

In the moving step, the user moves the endoscope device 10. When the motion information generated by the posture sensor 52 indicates a large motion, the inspection scene is “moving.”

The motion information generated by the posture sensor 52 may be used to determine the inspection scenes in the insertion step, the observation step, the recognition step, the measurement step, the return step, and the report step.

Information other than the aforementioned information may be used to determine the inspection scenes. For example, the position determined by the GPS sensor 51 may be used to determine the inspection scenes. When the distal end portion 2a or the like includes a temperature sensor, the temperature determined by the temperature sensor may be used to determine the inspection scenes.

The user intermittently performs the bending operation or the like. Even when the user does not perform an operation within a predetermined period after the user has performed a certain operation, a determination result indicating that the user has performed the operation is maintained.

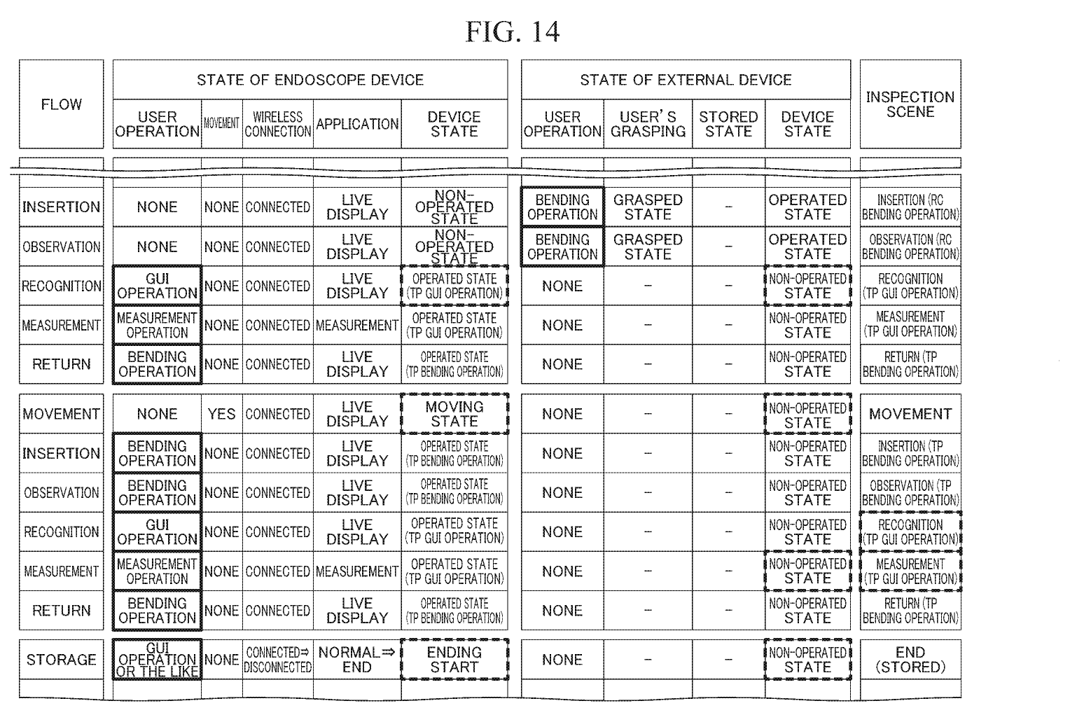

The endoscope system 1 according to the first embodiment determines that the user has forgotten carrying the external device 7 when the inspection state matches a predetermined state and notifies the user that the external device 7 has been left behind. FIG. 14 shows an example of a principal state in which there is a likelihood that the user has forgotten carrying the external device 7. The device states and the inspection scenes shown in FIG. 14 are the same as the device states and the inspection scenes shown in FIG. 10.

In a first example, the device state of the endoscope device 10 is an arbitrary state, and the device state of the external device 7 is a non-operated state. For example, as shown in FIG. 14, in the recognition step, the device state of the endoscope device 10 is an operated state corresponding to the operation of the touch panel 54 (TP GUI operation), and the device state of the external device 7 is the non-operated state. At this time, there is a likelihood that the user has forgotten carrying the external device 7.

In a second example, the device state of the endoscope device 10 is a moving state, and the device state of the external device 7 is the non-operated state. For example, as shown in FIG. 14, in the moving step, the device state of the endoscope device 10 is the moving state, and the device state of the external device 7 is the non-operated state. At this time, there is a likelihood that the user has forgotten carrying the external device 7.

In a third example, the device state of the endoscope device 10 is an ending start state, and the device state of the external device 7 is the non-operated state. For example, as shown in FIG. 14, in the storage step, the device state of the endoscope device 10 is an ending start state, and the device state of the external device 7 is the non-operated state. At this time, there is a likelihood that the user has forgotten carrying the external device 7.

In a fourth example, the inspection scene changes, and the device state of the external device 7 is the non-operated state. For example, as shown in FIG. 14, when the inspection scene changes from “recognition” to “measurement,” the device state of the external device 7 is the non-operated state. At this time, there is a likelihood that the user has forgotten carrying the external device 7.

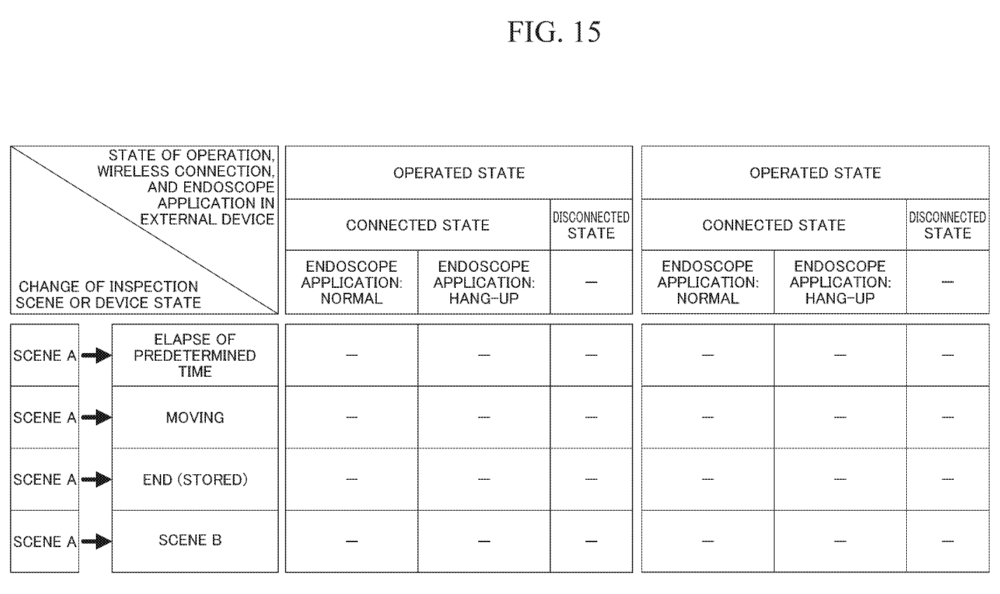

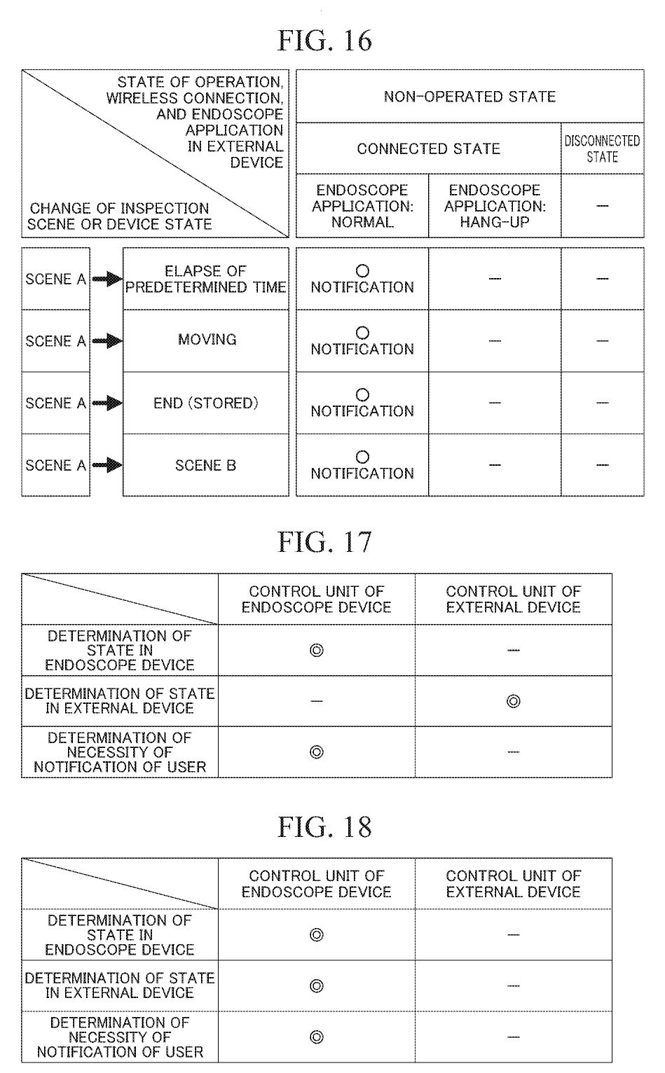

FIGS. 15 and 16 show an example of a situation in which notification of a user is necessary in accordance with the change of the inspection scene or the device state, the operation state of the external device 7, the state of the wireless connection, and the state of the endoscope application.

When the external device 7 is being operated, the user grasps the external device 7. Accordingly, it is not necessary to notify the user in an arbitrary state of the wireless connection and an arbitrary state of the endoscope application.

When the device state of the external device 7 is the non-operated state, the wireless connection is maintained, and the endoscope application operates normally, it is necessary to notify the user in accordance with the change of the inspection scene. In the first example, at a timing at which a predetermined time has elapsed from the timing at which the inspection scene has changed to an arbitrary scene A, the endoscope system 1 notifies the user that the user has forgotten carrying the external device 7. In the second example, when the inspection scene has changed from an arbitrary scene A to “moving,” the endoscope system 1 notifies the user that the user has forgotten carrying the external device 7. In the third example, when the inspection scene has changed from an arbitrary scene A to “end (stored),” the endoscope system 1 notifies the user that the user has forgotten carrying the external device 7. In the fourth example, when the inspection scene has changed from an arbitrary scene A to a scene B associated with the operation of the touch panel 54, the endoscope system 1 notifies the user that the user has forgotten carrying the external device 7.

The endoscope system 1 determines whether to notify the user in accordance with various states of the endoscope device 10 and various states of the external device 7. Alternatively, the endoscope system 1 determines whether to notify the user in accordance with various state of the devices and the inspection scene.

FIGS. 17 to 24 show examples in which processes are shared by the control unit of the endoscope device 10 and the control unit 70 of the external device 7. The control unit of the endoscope device 10 is at least one of the control unit 40 and the control unit 50. In the following eight examples, the communication unit 42 and the communication unit 57 execute communication according to necessity.

FIG. 17 shows a first example in which processes are shared by the control unit of the endoscope device 10 and the control unit 70 of the external device 7. The control unit of the endoscope device 10 determines the state of the endoscope device 10 based on information acquired in the endoscope device 10. The control unit 70 of the external device 7 determines the state of the external device 7 based on information acquired in the external device 7. The communication unit 72 transmits information indicating the determination result of the state of the external device 7 to the communication unit 58.

The control unit of the endoscope device 10 determines whether to notify the user based on the determination result of the state of the endoscope device 10 and the determination result of the state of the external device 7. The control unit of the endoscope device 10 may determine the inspection scene according to necessity.

FIG. 18 shows a second example in which processes are shared by the control unit of the endoscope device 10 and the control unit 70 of the external device 7. The control unit of the endoscope device 10 determines the state of the endoscope device 10 based on information acquired in the endoscope device 10. The communication unit 72 transmits information acquired in the external device 7 to the communication unit 58. The control unit of the endoscope device 10 determines the state of the external device 7 based on the information acquired in the external device 7.

The control unit of the endoscope device 10 determines whether to notify the user based on the determination result of the state of the endoscope device 10 and the determination result of the state of the external device 7. The control unit of the endoscope device 10 may determine the inspection scene according to necessity.

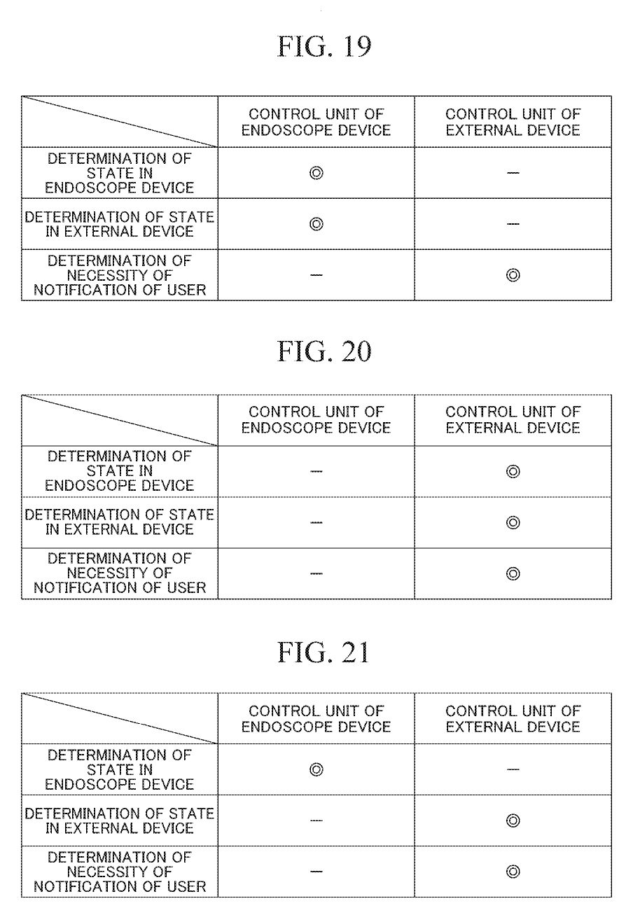

FIG. 19 shows a third example in which processes are shared by the control unit of the endoscope device 10 and the control unit 70 of the external device 7. The control unit of the endoscope device 10 determines the state of the endoscope device 10 based on information acquired in the endoscope device 10. The communication unit 72 transmits information acquired in the external device 7 to the communication unit 58. The control unit of the endoscope device 10 determines the state of the external device 7 based on the information acquired in the external device 7.

The communication unit 58 transmits information indicating the determination result of the state of the endoscope device 10 and information indicating the determination result of the state of the external device 7 to the communication unit 72. The control unit 70 of the external device 7 determines whether to notify the user based on the determination result of the state of the endoscope device 10 and the determination result of the state of the external device 7. The control unit 70 of the external device 7 may determine the inspection scene according to necessity.

FIG. 20 shows a fourth example in which processes are shared by the control unit of the endoscope device 10 and the control unit 70 of the external device 7. The communication unit 58 transmits information acquired in the endoscope device 10 to the communication unit 72. The control unit 70 of the external device 7 determines the state of the endoscope device 10 based on the information acquired in the endoscope device 10. The control unit 70 of the external device 7 determines the state of the external device 7 based on information acquired in the external device 7.

The control unit 70 of the external device 7 determines whether to notify the user based on the determination result of the state of the endoscope device 10 and the determination result of the state of the external device 7. The control unit 70 of the external device 7 may determine the inspection scene according to necessity.

FIG. 21 shows a fifth example in which processes are shared by the control unit of the endoscope device 10 and the control unit 70 of the external device 7. The control unit of the endoscope device 10 determines the state of the endoscope device 10 based on information acquired in the endoscope device 10. The communication unit 58 transmits information indicating the determination result of the state of the endoscope device 10 to the communication unit 72. The control unit 70 of the external device 7 determines the state of the external device 7 based on information acquired in the external device 7.

The control unit 70 of the external device 7 determines whether to notify the user based on the determination result of the state of the endoscope device 10 and the determination result of the state of the external device 7. The control unit 70 of the external device 7 may determine the inspection scene according to necessity.

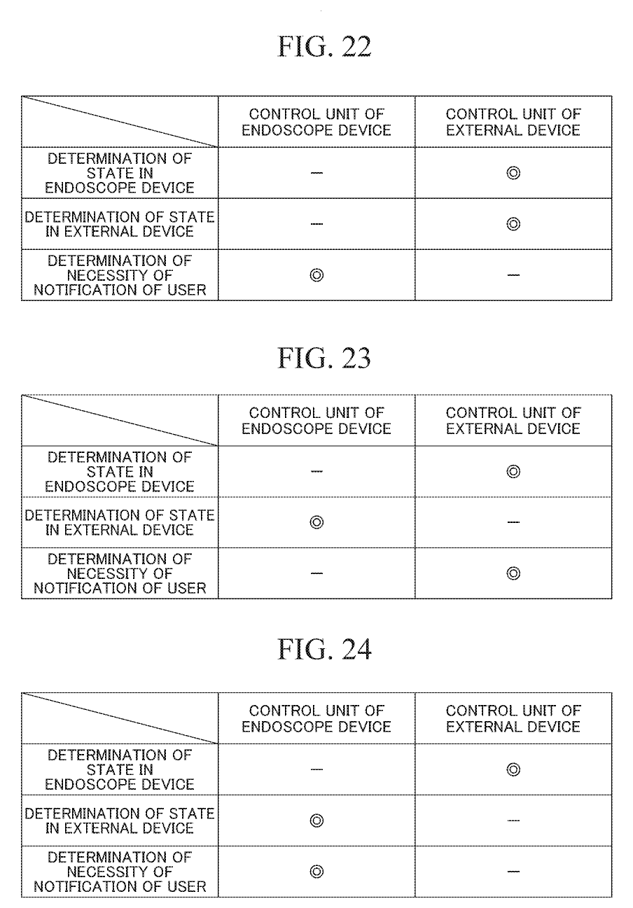

FIG. 22 shows a sixth example in which processes are shared by the control unit of the endoscope device 10 and the control unit 70 of the external device 7. The communication unit 58 transmits information acquired in the endoscope device 10 to the communication unit 72. The control unit 70 of the external device 7 determines the state of the endoscope device 10 based on the information acquired in the endoscope device 10. The control unit 70 of the external device 7 determines the state of the external device 7 based on information acquired in the external device 7. The communication unit 72 transmits information indicating the determination result of the state of the endoscope device 10 and information indicating the determination result of the state of the external device 7 to the communication unit 58.

The control unit of the endoscope device 10 determines whether to notify the user based on the determination result of the state of the endoscope device 10 and the determination result of the state of the external device 7. The control unit of the endoscope device 10 may determine the inspection scene according to necessity.

FIG. 23 shows a seventh example in which processes are shared by the control unit of the endoscope device 10 and the control unit 70 of the external device 7. The communication unit 58 transmits information acquired in the endoscope device 10 to the communication unit 72. The control unit 70 of the external device 7 determines the state of the endoscope device 10 based on the information acquired in the endoscope device 10. The communication unit 72 transmits information acquired in the external device 7 to the communication unit 58. The control unit of the endoscope device 10 determines the state of the external device 7 based on the information acquired in the external device 7. The communication unit 58 transmits information indicating the determination result of the state of the external device 7 to the communication unit 72.

The control unit 70 of the external device 7 determines whether to notify the user based on the determination result of the state of the endoscope device 10 and the determination result of the state of the external device 7. The control unit 70 of the external device 7 may determine the inspection scene according to necessity.

FIG. 24 shows an eighth example in which processes are shared by the control unit of the endoscope device 10 and the control unit 70 of the external device 7. The communication unit 58 transmits information acquired in the endoscope device 10 to the communication unit 72. The control unit 70 of the external device 7 determines the state of the endoscope device 10 based on the information acquired in the endoscope device 10. The communication unit 72 transmits information indicating the determination result of the state of the endoscope device 10 to the communication unit 58. The communication unit 72 transmits information acquired in the external device 7 to the communication unit 58. The control unit of the endoscope device 10 determines the state of the external device 7 based on the information acquired in the external device 7.

The control unit of the endoscope device 10 determines whether to notify the user based on the determination result of the state of the endoscope device 10 and the determination result of the state of the external device 7. The control unit of the endoscope device 10 may determine the inspection scene according to necessity.

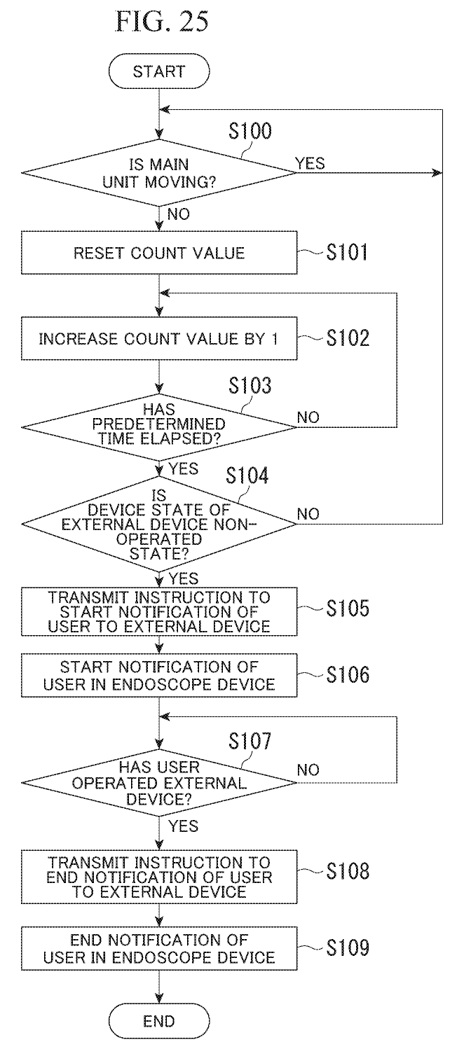

FIG. 25 shows an example of a procedure of a process executed by the endoscope device 10. The process shown in FIG. 25 corresponds to the first example shown in FIGS. 15 and 16. The control unit 50 of the main unit 5 executes the process shown in FIG. 25. The control unit 40 of the base unit 4 and the control unit 50 of the main unit 5 may share the process shown in FIG. 25. In this case, the communication unit 42 and the communication unit 57 execute communication of information required for the process.

The power supplies of the scope unit 3, the base unit 4, and the main unit 5 are turned on, and the endoscope application starts its operation. The communication unit 58 and the communication unit 72 start wireless communication. Thereafter, the process shown in FIG. 25 starts.

The communication unit 58 periodically receives information indicating the result of determination of the device state of the external device 7 executed by the control unit 70 of the external device 7 and outputs the received information to the control unit 50. The control unit 50 stores the received information in the volatile memory 59. This process is executed in parallel with the process shown in FIG. 25.

The control unit 50 acquires information indicating the moving state of the main unit 5 from the posture sensor 52. The control unit 50 determines whether the main unit 5 is moving based on the information (Step S100).

Details of Step S100 will be described. The control unit 50 sets a roll axis, a pitch axis, and a yaw axis that are perpendicular to each other at a first timing. The control unit 50 calculates the amount of rotation of the main unit 5 around each of the three axes at a second timing after the first timing. The calculated amounts of rotation indicate the amount of movement of the main unit 5 from the first timing to the second timing. The control unit 50 compares each of the three amounts of rotation with a threshold value. When at least one of the three amounts of rotation is greater than the threshold value, the control unit 50 determines that the main unit 5 is moving. When all of the three amounts of rotation are less than or equal to the threshold value, the control unit 50 determines that the main unit 5 is stationary.

When the control unit 50 determines that the main unit 5 is moving in Step S100, the control unit 50 executes the determination of Step S100 again. When the control unit 50 determines that the main unit 5 is stationary in Step S100, the control unit 50 resets a count value for measuring time. At this time, the count value is 0 (Step S101).

After Step S101, the control unit 50 increases the count value by 1 (Step S102).

After Step S102, the control unit 50 determines whether the count value is greater than or equal to a threshold value. Accordingly, the control unit 50 determines whether a predetermined time has elapsed (Step S103).

When the control unit 50 determines that the count value is less than the threshold value, that is, the predetermined time has not elapsed, in Step S103, Step S102 is executed. When the control unit 50 determines that the count value is greater than or equal to the threshold value, that is, the predetermined time has elapsed, in Step S103, the control unit 50 determines whether the device state of the external device 7 is a non-operated state based on the information received from the external device 7 (Step S104). The non-operated state is a state in which the external device 7 is not stored in the storage portion 61 and a user is not operating the external device 7.

When the control unit 50 determines that the device state of the external device 7 is not the non-operated state in Step S104, Step S100 is executed. When the control unit 50 determines that the device state of the external device 7 is the non-operated state in Step S104, the control unit 50 outputs an instruction for the external device 7 to start notification of the user to the communication unit 58. The communication unit 58 transmits the instruction to the communication unit 72 (Step S105).

After Step S105, the control unit 50 starts notification of the user (Step S106).

Details of Step S106 will be described. For example, the control unit 50 outputs a message for notifying the user that the user has forgotten carrying the external device 7 to the display 53 and displays the message on the display 53. The control unit 50 may cause the screen of the display 53 to flicker. The control unit 50 may output a warning sound for notifying the user that the user has forgotten carrying the external device 7 from the speaker 56. When the main unit 5 includes a vibration generator, the control unit 50 may cause the vibration generator to generate vibration for notifying the user that the user has forgotten carrying the external device 7.

After Step S106, the control unit 50 refers to information received from the external device 7 and determines whether the user has operated the external device 7 after the notification of the user has been started (Step S107).

Details of Step S107 will be described. The information received from the external device 7 indicates the device state of the external device 7. When the device state of the external device 7 is the non-operated state, the control unit 50 determines that the user has not operated the external device 7 after the notification of the user has been started. When the device state of the external device 7 is an operated state, the control unit 50 determines that the user has operated the external device 7 after the notification of the user has been started.

When the control unit 50 determines that the user has not operated the external device 7 after the notification of the user has been started in Step S107, the control unit 50 executes the determination of Step S107 again. When the control unit 50 determines that the user has operated the external device 7 after the notification of the user has been started in Step S107, the control unit 50 outputs an instruction to end the notification of the user to the communication unit 58. The communication unit 58 transmits the instruction to the communication unit 72 (Step S108).

After Step S108, the control unit 50 ends the notification started in Step S106 (Step S109). When Step S109 is executed, the process shown in FIG. 25 ends.

The control unit 50 may not execute Step S100 and perform Step S101. The control unit 50 may execute only one of Steps S105 and S106.

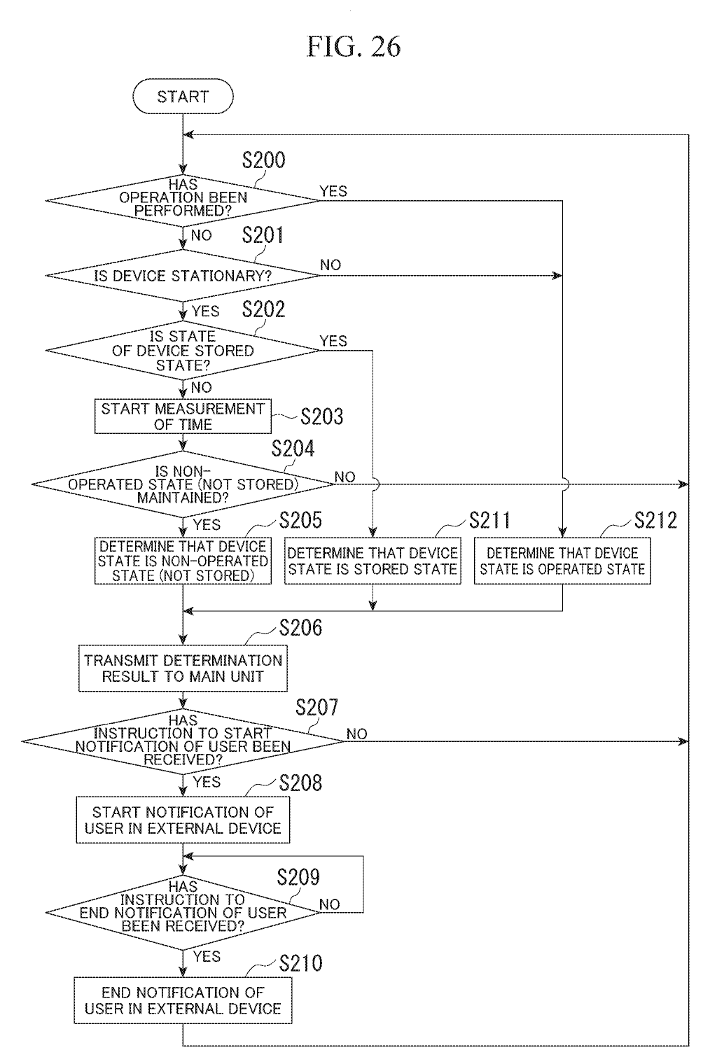

FIG. 26 shows an example of a procedure of a process executed by the external device 7. The process shown in FIG. 26 corresponds to the first example shown in FIGS. 15 and 16.

The control unit 70 of the external device 7 acquires information output from the posture sensor 71, the joystick 74, and the operation unit 75 and determines whether the bending operation or the operation of the operation unit 75 has been executed (Step S200). The bending operation is the joystick operation or the tilting operation.

When the control unit 70 determines that the bending operation or the operation of the operation unit 75 has been executed in Step S200, Step S212 is executed. When the control unit 70 determines that none of the bending operation or the operation of the operation unit 75 has been executed in Step S200, the control unit 70 acquires information indicating the motion state of the external device 7 from the posture sensor 71. The control unit 70 determines whether the external device 7 is stationary based on the information (Step S201).

Details of Step S201 will be described. The control unit 70 sets a roll axis, a pitch axis, and a yaw axis that are perpendicular to each other at a first timing. The control unit 70 calculates the amount of rotation of the external device 7 around each of the three axes at a second timing after the first timing. The calculated amounts of rotation indicate the amount of movement of the external device 7 from the first timing to the second timing. The control unit 70 compares each of the three amounts of rotation with a threshold value. When all of the three amounts of rotation are less than or equal to the threshold value, the control unit 70 determines that the external device 7 is stationary. When at least one of the three amounts of rotation is greater than the threshold value, the control unit 50 determines that the external device 7 is moving.

When the control unit 70 determines that the external device 7 is not stationary in Step S201, Step S212 is executed. When the control unit 70 determines that the external device 7 is stationary in Step S201, the control unit 70 determines whether the state of the external device 7 is a stored state based on information acquired from the posture sensor 71 (Step S202).

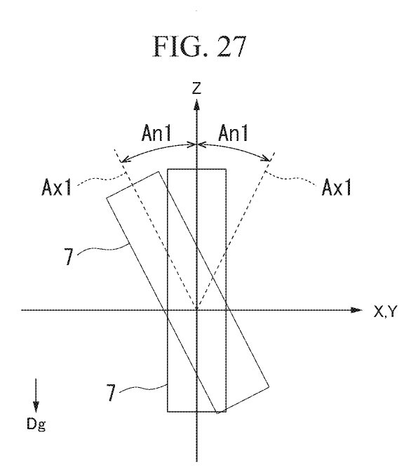

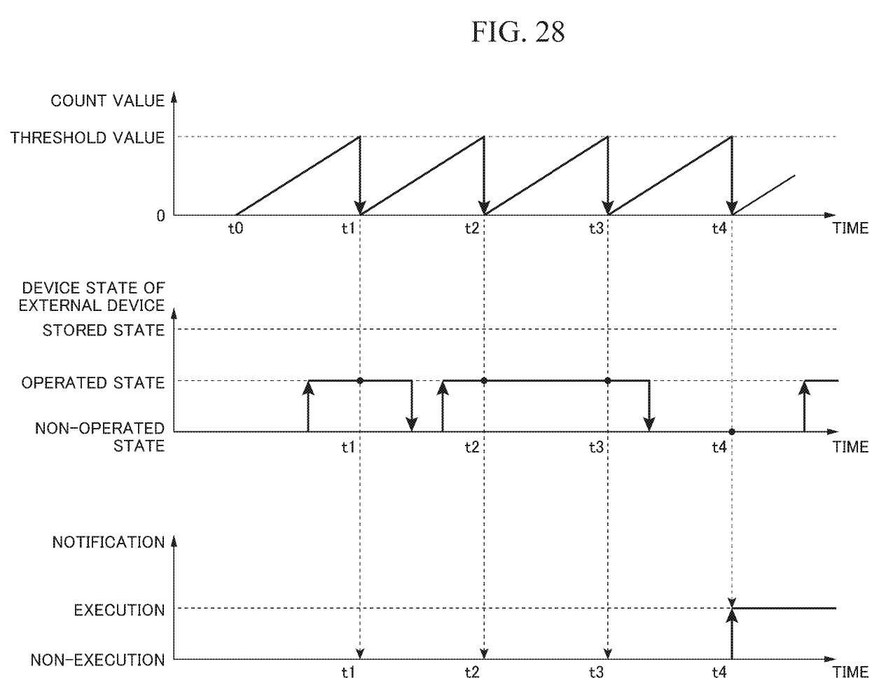

Details of Step S202 will be described. The control unit 70 determines the posture of the external device 7 based on information acquired from the posture sensor 71. FIG. 27 shows an example of the posture of the external device 7. The control unit 70 calculates an angle An1 between the Z axis (the yaw axis) parallel to the gravitational direction Dg and an axis Ax1 extending in the longitudinal direction of the external device 7. When the angle An1 is less than a threshold value, the control unit 70 determines that the state of the external device 7 is the stored state. When the angle An1 is greater than or equal to the threshold value, the control unit 70 determines that the state of the external device 7 is not the stored state.

Inspection may be performed in a state in which the main unit 5 is disposed such that the screen of the main unit 5 is parallel to the gravitational direction Dg. In this inspection, when the external device 7 is stored in the storage portion 61, the axis Ax1 is parallel to the gravitational direction. The threshold value in this inspection is, for example, 35 degrees.

On the other hand, inspection may be performed in a state in which the main unit 5 is disposed such that the screen of the main unit 5 is tilted with respect to the gravitational direction Dg. In this inspection, when the external device 7 is stored in the storage portion 61, the axis Ax1 is not parallel to the gravitational direction. The threshold value in this inspection may be greater than 35 degrees.

For example, the control unit 50 outputs information indicating the posture of the main unit 5 determined by the posture sensor 52 to the communication unit 58. The communication unit 58 transmits the information to the communication unit 72. The notification unit 72 receives the information and outputs the information to the control unit 70 via the communication control unit 73. The control unit 70 calculates an angle between the direction parallel to the screen of the main unit 5 and the gravitational direction Dg based on the posture of the main unit 5 indicated by the information. When the screen of the main unit 5 is parallel to the gravitational direction Dg, the angle between the direction parallel to the screen of the main unit 5 and the gravitational direction Dg is 0 degrees.

The control unit 70 sets a threshold value in accordance with the calculated angle. For example, the threshold value is a value obtained by adding a predetermined value (for example, 35 degrees) to the calculated angle. The control unit 70 determines the posture of the external device 7 using the set threshold value.

When the control unit 70 determines that the state of the external device 7 is the stored state in Step S202, Step S211 is executed. When the control unit 70 determines that the state of the external device 7 is not the stored state in Step S202, the control unit 70 starts measurement of time (Step S203). When the measurement of time has started already, Step S203 is skipped. When Step S211 or Step S212 is executed after the measurement of time has started, the measurement of time ends.

After Step S203, the control unit 70 determines whether the measured time is longer than a predetermined time. Accordingly, the control unit 70 determines whether the external device 7 is not stored in the storage portion 61 and the non-operated state is maintained (Step S204).

When the control unit 70 determines that the measured time is shorter than or equal to the predetermined time, that is, the non-operated state is not maintained, in Step S204, Step S200 is executed. When the control unit 70 determines that the measured time is longer than the predetermined time, that is, the external device 7 is not stored in the storage portion 61 and the non-operated state is maintained, in Step S204, the control unit 70 determines that the device state is the non-operated state (Step S205).

After Step S205, the control unit 70 outputs information indicating that the device state is the non-operated state to the communication control unit 73. The communication control unit 73 transmits the information to the communication unit 58 via the communication unit 72 (Step S206).

After Step S206, the control unit 70 determines whether an instruction to start notification of the user has been received (Step S207).

When the control unit 70 determines that the instruction to start notification of the user has not been received in Step S207, Step S200 is executed. When the control unit 70 determines that the instruction to start notification of the user has been received in Step S207, the control unit 70 starts notification of the user (Step S208).

Details of Step S208 will be described. For example, the control unit 70 causes the LED 76 to flicker in order to notify the user that the user has forgotten carrying the external device 7. The control unit 70 may output a warning sound for notifying the user that the user has forgotten carrying the external device 7 from the speaker 77. The control unit 70 may cause the vibration generator 78 to generate vibration for notifying the user that the user has forgotten carrying the external device 7.

After Step S208, the control unit 70 periodically executes Steps S200 to S206 and Steps S211 and S212. These processes are executed in parallel with Step S209.

After Step S208, the control unit 70 determines whether an instruction to end notification of the user has been received (Step S209).

When the control unit 70 determines that the instruction to end notification of the user has not been received in Step S209, the control unit 70 executes the determination of Step S209 again. When the control unit 70 determines that the instruction to end notification of the user has been received in Step S209, the control unit 70 ends the notification started in Step S208 (Step S210). After Step S210, Step S200 is executed.

When the control unit 70 determines that the state of the external device 7 is the stored state in Step S202, the control unit 70 determines that the device state is the stored state (Step S211). After Step S211, information indicating that the device state is the stored state is transmitted in Step S206.

When the control unit 70 determines that none of the bending operation or the operation of the operation unit 75 has been executed in Step S200 or when the control unit 70 determines that the external device 7 is not stationary in Step S201, the control unit 70 determines that the device state is an operated state (Step S212). After Step S212, information indicating that the device state is the operated state is transmitted in Step S206.

FIG. 28 shows an example of the change of the count value, the change of the device state of the external device 7, and the change of the execution state of notification of a user.

Measurement of time in the endoscope device 10 starts at time t0. Thereafter, the counter value increases.

At time t1, the count value becomes a predetermined value and is reset. Since the device state of the external device 7 at time t1 is the operated state, notification of the user is not executed.

Thereafter, at time t2, the count value becomes a predetermined value and is reset. Since the device state of the external device 7 at time t2 is the operated state, notification of the user is not executed.

Thereafter, at time t3, the count value becomes a predetermined value and is reset. Since the device state of the external device 7 at time t3 is the operated state, notification of the user is not executed.

Thereafter, at time t4, the count value becomes a predetermined value and is reset. Since the device state of the external device 7 at time t4 is the non-operated state, notification of the user is executed.

As shown in FIG. 28, the control unit 50 periodically executes determination of whether to execute notification of a user at intervals of a predetermined time. By setting the predetermined time to a certain length, the frequency in which notification of the user is executed can be decreased.

In the example shown in FIG. 25, the control unit 50 determines the device state of the main unit 5 based on the moving state (first state information) of the main unit 5 and the time (first state information) in the inspection. In the example shown in FIG. 26, the control unit 70 determines the device state of the external device 7 based on the operation state (second operation information) of the external device 7, the moving state (second state information) of the external device 7, and the posture (second state information) of the external device 7. The control unit 50 determines whether notification of a user is necessary based on the device state of the main unit 5 and the device state of the external device 7.

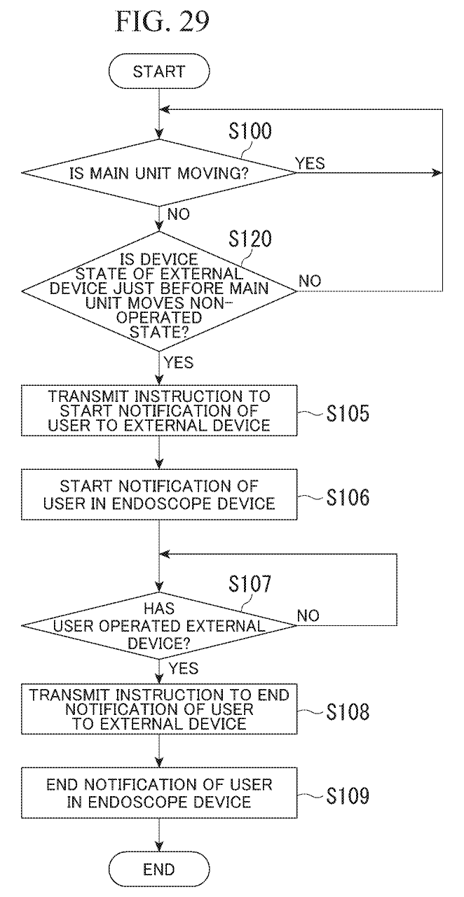

FIG. 29 shows another example of a procedure of a process executed by the endoscope device 10. The process shown in FIG. 29 corresponds to the second example shown in FIGS. 15 and 16. The control unit 50 of the main unit 5 executes the process shown in FIG. 29. The process shown in FIG. 29 may be shared by the control unit 40 of the base unit 4 and the control unit 50 of the main unit 5. In this case, the communication unit 42 and the communication unit 57 execute communication of information required for the process. The same processes as those in the process shown in FIG. 25 will not be described.

When the control unit 50 determines that the main unit 5 is stationary in Step S100, the control unit 50 determines whether the device state of the external device 7 just before the main unit 5 moves is the non-operated state (Step S120).

Details of Step S120 will be described. As described above, the communication unit 58 periodically receives information indicating the result of determination of the device state of the external device 7 executed by the control unit 70 of the external device 7. The information is stored in the volatile memory 59. When the control unit 50 determines that the main unit 5 is stationary in Step S100, the control unit 50 refers to the newest information stored in the volatile memory 59. The control unit 50 determines whether the device state of the external device 7 is the non-operated state based on the information.

When the control unit 50 determines that the device state of the external device 7 just before the main unit 5 moves is not the non-operated state in Step S120, Step S100 is executed. When the control unit 50 determines that the device state of the external device 7 just before the main unit 5 moves is the non-operated state in Step S120, Step S105 is executed.

The control unit 50 may execute only one of Steps S105 and S106.

The external device 7 executes the process shown in FIG. 26. The process executed by the external device 7 will not be described.

In the example shown in FIG. 29, the control unit 50 determines the device state of the main unit 5 based on the moving state (first state information) of the main unit 5. The control unit 50 determines whether notification of a user is necessary based on the device state of the main unit 5 and the device state of the external device 7.

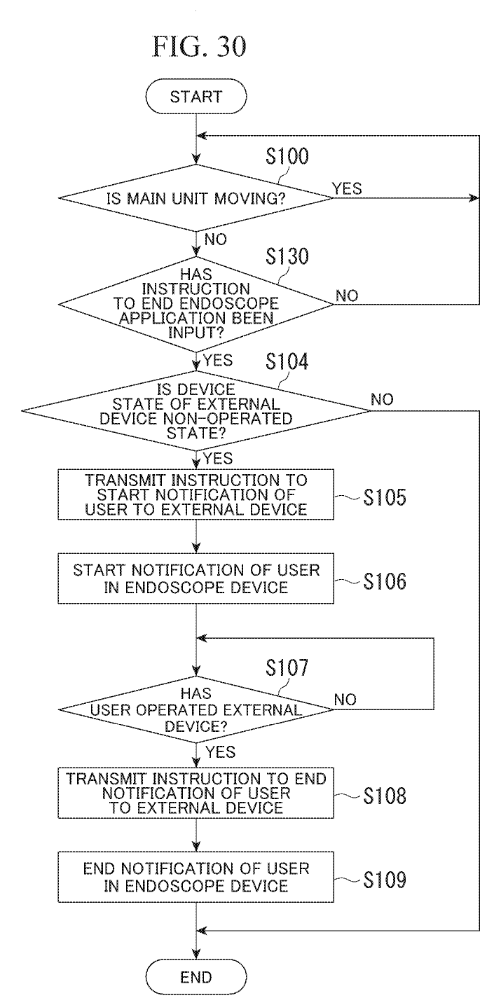

FIG. 30 shows another example of a procedure of a process executed by the endoscope device 10. The process shown in FIG. 30 corresponds to the third example shown in FIGS. 15 and 16. The control unit 50 of the main unit 5 executes the process shown in FIG. 30. The process shown in FIG. 30 may be shared by the control unit 40 of the base unit 4 and the control unit 50 of the main unit 5. In this case, the communication unit 42 and the communication unit 57 execute communication of information required for the process. The same processes as those in the process shown in FIG. 25 will not be described.

When the control unit 50 determines that the main unit 5 is stationary in Step S100, the control unit 50 acquires information output from the touch panel 54 and determines whether an instruction to end the endoscope application has been input (Step S130).

When the control unit 50 determines that the instruction to end the endoscope application has not been input in Step S130, Step S100 is executed. When the control unit 50 determines that the instruction to end the endoscope application has been input in Step S130, Step S104 is executed.

The control unit 50 may not execute Step S100 and execute Step S130. The control unit 50 may execute only one of Steps S105 and S106.

The external device 7 executes the process shown in FIG. 26. The process executed by the external device 7 will not be described.

In the example shown in FIG. 30, the control unit 50 determines the device state of the main unit 5 based on the moving state (first state information) of the main unit 5 and the operation state (first operation information) for ending the endoscope application. The control unit 50 determines whether notification of a user is necessary based on the device state of the main unit 5 and the device state of the external device 7.

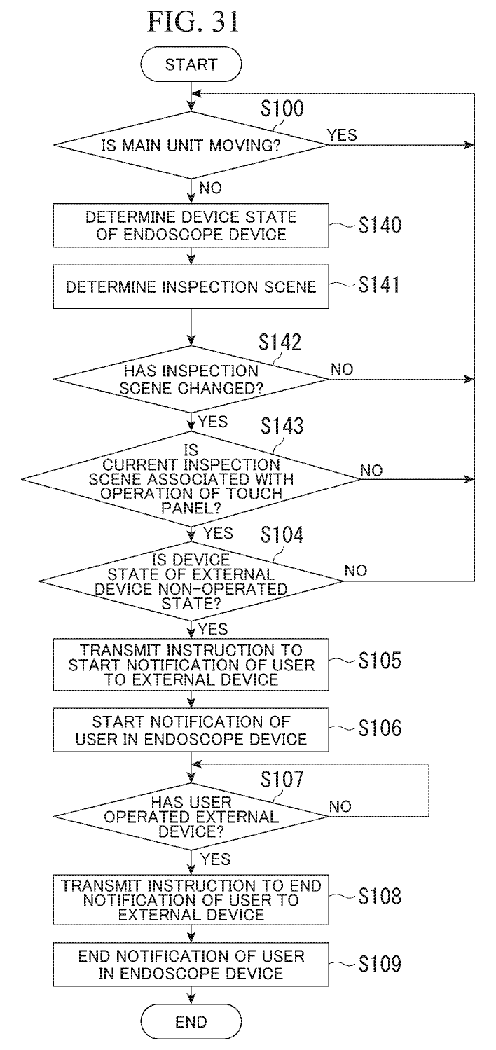

FIG. 31 shows another example of a procedure of a process executed by the endoscope device 10. The process shown in FIG. 31 corresponds to the fourth example shown in FIGS. 15 and 16. The control unit 50 of the main unit 5 executes the process shown in FIG. 31. The process shown in FIG. 31 may be shared by the control unit 40 of the base unit 4 and the control unit 50 of the main unit 5. In this case, the communication unit 42 and the communication unit 57 execute communication of information required for the process. The same processes as those in the process shown in FIG. 25 will not be described.

When the control unit 50 determines that the main unit 5 is stationary in Step S100, the control unit 50 determines the device state of the endoscope device 10 based on the operation state or the like of the touch panel 54 (Step S140).

As described above, the communication unit 58 periodically receives information indicating the result of determination of the device state of the external device 7 executed by the control unit 70 of the external device 7. The information is stored in the volatile memory 59. After Step S140, the control unit 50 determines the inspection scene based on the device state of the endoscope device 10 and the device state of the external device 7 (Step S141).

After Step S141, the control unit 50 determines whether the inspection scene has changed (Step S142). When Step S141 has been executed only once, the control unit 50 determines that the inspection scene has not changed. When Step S141 has been executed twice or more, the control unit 50 determines whether the inspection scene has changed based on the inspection scene determined in previous Step S141 and the inspection scene determined in Step S141 before last.

When the control unit 50 determines that the inspection scene has not changed in Step S142, Step S100 is executed. When the control unit 50 determines that the inspection scene has changed in Step S142, the control unit 50 determines whether the current inspection scene is a scene associated with the operation of the touch panel 54 (Step S143). The scene associated with the operation of the touch panel 54 is “insertion” accompanying the bending operation in the touch panel 54 (TP bending operation), “observation” accompanying the TP bending operation, “recognition” accompanying the bending operation of the touch panel 54 (TP GUI operation), “measurement” accompanying the TP GUI operation, or “return” accompanying the TP bending operation.

When the control unit 50 determines that the current inspection scene is not a scene associated with the operation of the touch panel 54 in Step S143, Step S100 is executed. When the control unit 50 determines that the current inspection scene is a scene associated with the operation of the touch panel 54 in Step S143, Step S104 is executed.

The control unit 50 may not execute Step S100 and execute Step S140. The control unit 50 may execute only one of Steps S105 and S106.

The external device 7 executes the process shown in FIG. 26. The process executed by the external device 7 will not be described.

In the example shown in FIG. 31, the control unit 50 determines the device state of the main unit 5 based on the moving state (first state information) of the main unit 5 and the change of the inspection scene with respect to the operation of the touch panel 54 (first state information). The control unit 50 determines whether notification of a user is necessary based on the device state of the main unit 5 and the device state of the external device 7.

The control unit 50 may identify an inspection site based on information indicating the position of the main unit 5 determined by the GPS sensor 51. The control unit 50 may control notification of a user in accordance with the identified inspection site. For example, when the inspection site is a place registered in advance as an inspection site for an aircraft, the control unit 50 executes notification of a user by combining a plurality of means. The plurality of means include two or more of the display 53, the speaker 56, the LED 76, the speaker 77, and the vibration generator 78. When the inspection site is an office or the like, the control unit 50 limits notification of a user. For example, the control unit 50 displays a small message on the display 53.

The control unit 50 may control notification of a user in accordance with the current time indicated by time information generated in the main unit 5. For example, in the nighttime, the control unit 50 executes notification of a user using the LED 76. In the daytime, the control unit 50 executes notification of a user using another means instead of the LED 76 in order to save power.

The endoscope system 1 according to each aspect of the present invention includes the endoscope device 10 and the external device 7. The endoscope device 10 includes the insertion unit 2, a first operation device, a control unit (a first control unit), and the communication unit 42 (a first communicator). For example, the first operation device includes at least the touch panel 54. The first operation device may include at least one of the operation button 41 and the operation button 55. For example, the control unit of the endoscope device 10 is at least one of the control unit 40 and the control unit 50.

The insertion unit 2 is bendable and acquires an optical image in an observation target. The first operation device receives an operation including a bending operation for bending the insertion unit 2. The control unit of the endoscope device 10 acquires at least one of first operation information and first state information. The first operation information indicates an operation received by the first operation device. The first state information indicates a state of the endoscope device 10. The communication unit 42 executes wireless communication associated with control of the endoscope device 10.

The external device 7 includes a second operation device, the posture sensor 71 (a second sensor), the control unit 70 (a second control unit), and the communication unit 72 (a second communicator). For example, the second operation device includes at least the joystick 74. The second operation device may include at least part of the operation unit 75.

The second operation device receives an operation including the bending operation. The posture sensor 71 determines the state of the external device 7. The control unit 70 acquires second operation information and second state information. The second operation information indicates the operation received by the second operation device. The second state information indicates the state determined by the posture sensor 71. The communication unit 72 executes the wireless communication associated with control of the endoscope device 10.

At least one of the control unit of the endoscope device 10 and the control unit 70 executes a determination process of determining whether the external device 7 is stored in the storage portion 61 and whether the external device 7 is being operated based on at least one of the first operation information and the first state information and based on the second operation information and the second state information. At least one of the control unit of the endoscope device 10 and the control unit 70 causes a notification circuit included in the endoscope device 10 or the external device 7 to execute notification of information when it is determined that the external device 7 is not stored in the storage portion 61 and the external device 7 is not being operated. For example, the notification circuit is at least one of the display 53, the speaker 56, the LED 76, the speaker 77, and the vibration generator 78. When the control unit of the endoscope device 10 executes the determination process, the communication unit 72 transmits the second operation information and the second state information to the communication unit 58. When the control unit 70 executes the determination process, the communication unit 58 transmits at least one of the first operation information and the first state information to the communication unit 72.

An information notification method according to each aspect of the present invention includes first to sixth steps. In the first step (Steps S100, S103, S130, and S140), the control unit of the endoscope device 10 acquires at least one of the first operation information and the first state information. In the second step (Steps S200, S201, and S202), the control unit 70 acquires the second operation information and the second state information. In the third step (Step S104), at least one of the control unit of the endoscope device 10 and the control unit 70 executes a determination process of determining whether the external device 7 is stored in the storage portion 61 and whether the external device 7 is being operated based on at least one of the first operation information and the first state information and based on the second operation information and the second state information. When it is determined that the external device 7 is not stored in the storage portion 61 and the external device 7 is not being operated, at least one of the control unit of the endoscope device 10 and the control unit 70 causes a notification circuit included in the endoscope device 10 or the external device 7 to execute notification of information in the fourth step (Steps S105 and S106). When the control unit of the endoscope device 10 executes the determination process, the communication unit 72 transmits the second operation information and the second state information to the communication unit 58 in the fifth step (Step S206). When the control unit 70 executes the determination process, the communication unit 58 transmits at least one of the first operation information and the first state information to the communication unit 72 in the sixth step.

Each aspect of the present invention may include a following modified example. The endoscope device 10 further includes the posture sensor 52 (a first sensor) that determines the state of the endoscope device 10. At least one of the control unit of the endoscope device 10 and the control unit 70 executes the determination process based on at least one of the first operation information and the first state information indicating the state determined by the posture sensor 52 and based on the second operation information and the second state information.

Each aspect of the present invention may include a following modified example. The posture sensor 52 determines the moving state of the endoscope device 10.

Each aspect of the present invention may include a following modified example. The posture sensor 71 determines the moving state of the external device 7 and the posture of the external device 7.

Each aspect of the present invention may include a following modified example. At least one of the control unit of the endoscope device 10 and the control unit 70 executes the determination process based on at least one of the first operation information and the first state information and based on the second operation information and the second state information indicating whether the external device 7 is stationary in a preset posture.

Each aspect of the present invention may include a following modified example. The endoscope device 10 further includes the posture sensor 52 (a first sensor) that determines the posture of the endoscope device 10. The communication unit 58 transmits information indicating the posture determined by the posture sensor 52 to the communication unit 72. The control unit 70 sets a threshold value based on the posture indicated by the information received by the communication unit 72. The control unit 70 generates the second state information indicating whether the external device 7 is stationary in the preset posture based on the posture determined by the posture sensor 71 and the threshold value.

Each aspect of the present invention may include a following modified example. At least one of the control unit of the endoscope device 10 and the control unit 70 executes the determination process based on at least one of the first operation information indicating the bending operation or an operation on an application in the endoscope device 10 and the first state information and based on the second operation information and the second state information.

Each aspect of the present invention may include a following modified example. At least one of the control unit of the endoscope device 10 and the control unit 70 causes the notification circuit to continuously execute the notification of information after the notification of information has been started. At least one of the control unit of the endoscope device 10 and the control unit 70 determines whether the notification of information is to end based on at least one of the second operation information and the second state information. At least one of the control unit of the endoscope device 10 and the control unit 70 causes the notification circuit to end the notification of information when it is determined that the notification of information is to end.

Each aspect of the present invention may include a following modified example. The endoscope device 10 further includes the GPS sensor 51 that determines the position of the endoscope device 10. The communication unit 58 transmits information indicating the position of the endoscope device 10 to the communication unit 72 when the control unit 70 executes the determination process. At least one of the control unit of the endoscope device 10 and the control unit 70 controls the notification executed by the notification circuit based on the position.

Each aspect of the present invention may include a following modified example. At least one of the control unit of the endoscope device 10 and the control unit 70 controls the notification executed by the notification circuit based on the current time.

Each aspect of the present invention may include a following modified example. The communication unit 72 transmits the second operation information and the second state information to the communication unit 58. The control unit of the endoscope device 10 executes the determination process.

Each aspect of the present invention may include a following modified example. The control unit 70 determines the execution state of inspection in the external device 7 based on the second operation information and the second state information. The communication unit 72 transmits state information indicating the execution state of inspection to the communication unit 58. The control unit of the endoscope device 10 executes the determination process based on at least one of the first operation information and the first state information and based on the state information received by the communication unit 58.

Each aspect of the present invention may include a following modified example. The endoscope device 10 includes the scope unit 3 (a first housing) and the main unit 5 (a second housing). The insertion unit 2 is connected to the scope unit 3. The main unit 5 includes the first operation device and the control unit 50.

Each aspect of the present invention may include a following modified example. The second operation device includes the joystick 74 that receives the bending operation.

In the first embodiment, when there is a likelihood that a user has forgotten carrying the external device 7, the endoscope system 1 executes notification of the user. The endoscope system 1 can cause the user to be aware that the user has forgotten carrying the external device 7 and improve the inspection efficiency. In a predetermined inspection environment, next inspection may not be able to be performed until a wireless remote controller is found. In this case, there is a likelihood that the inspection efficiency will decrease and finding of the wireless remote controller will require costs. The endoscope system 1 can avoid such a case.

### First modified example of first embodiment

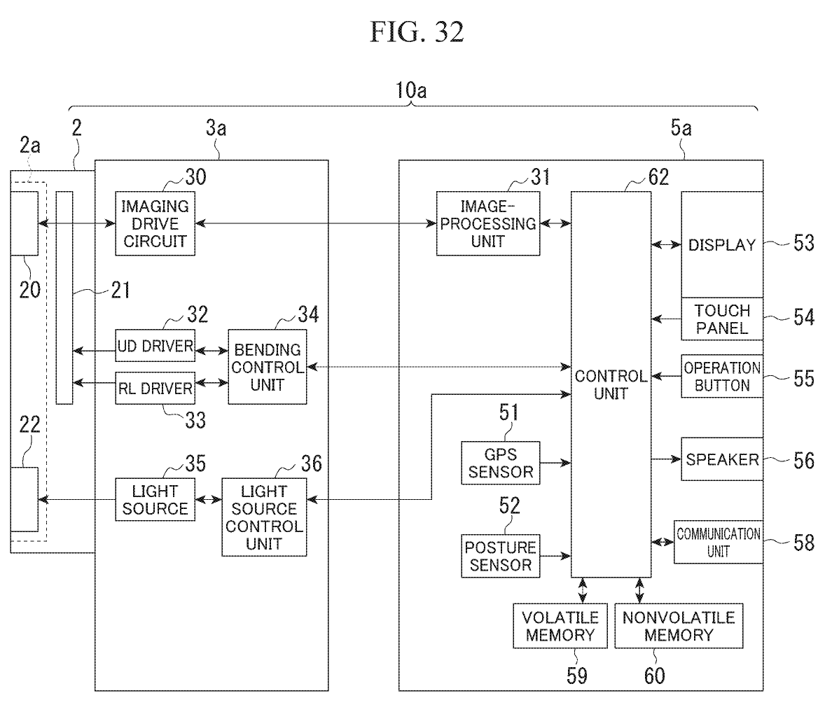

A first modified example of the first embodiment of the present invention will be described. FIG. 32 shows an example of the configuration of an endoscope device 10a according to the first modified example of the first embodiment. The endoscope system 1 includes an endoscope device 10a instead of the endoscope device 10. The same parts as those shown in FIG. 2 will not be described.

The endoscope device 10a shown in FIG. 32 includes an insertion unit 2, a scope unit 3a, and a main unit 5a. The scope unit 3a and the main unit 5a may be connected to each other via a cable. Alternatively, the scope unit 3a and the main unit 5a may execute wireless communication.

The insertion unit 2 shown in FIG. 32 is the same as the insertion unit 2 shown in FIG. 2. The scope unit 3a shown in FIG. 32 is the same as the scope unit 3 shown in FIG. 2 except that the image-processing unit 31 is not disposed. The main unit 5a includes an image-processing unit 31, a GPS sensor 51, a posture sensor 52, a display 53, a touch panel 54, an operation button 55, a speaker 56, a communication unit 58, a volatile memory 59, a nonvolatile memory 60, and a control unit 62. The same blocks as those shown in FIG. 2 are referred to by the same reference signs as those shown in FIG. 2.

The control unit 62 has both the function of the control unit 40 shown in FIG. 2 and the function of the control unit 50 shown in FIG. 2. The control unit 62 executes the process shown in FIGS. 25, 29, 30, or 31.

In the first modified example of the first embodiment, similarly to the first embodiment, the endoscope system 1 can cause the user to be aware that the user has forgotten carrying the external device 7 and improve the inspection efficiency.

### Second modified example of first embodiment

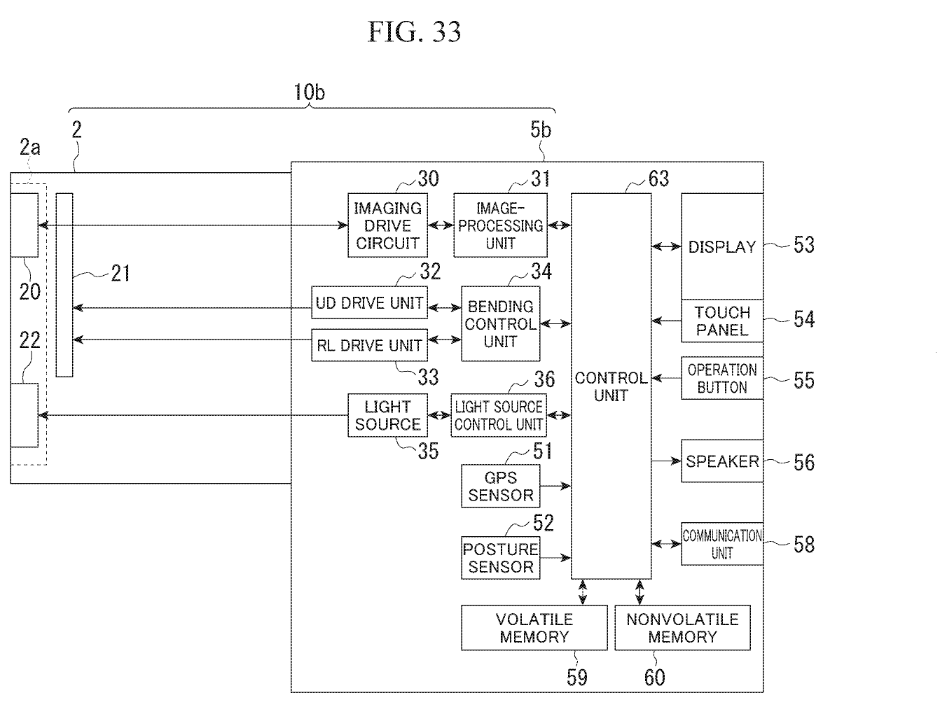

A second modified example of the first embodiment of the present invention will be described. FIG. 33 shows an example of the configuration of an endoscope device 10b according to the second modified example of the first embodiment. The endoscope system 1 includes an endoscope device 10b instead of the endoscope device 10. The same parts as those shown in FIG. 2 will not be described.

The endoscope device 10b shown in FIG. 33 includes an insertion unit 2 and a main unit 5b.

The insertion unit 2 shown in FIG. 33 is the same as the insertion unit 2 shown in FIG. 2. The main unit 5b includes an imaging drive circuit 30, an image-processing unit 31, a UD drive unit 32, an RL drive unit 33, a bending control unit 34, a light source 35, a light source control unit 36, a GPS sensor 51, a posture sensor 52, a display 53, a touch panel 54, an operation button 55, a speaker 56, a communication unit 58, a volatile memory 59, a nonvolatile memory 60, and a control unit 63. The same blocks as those shown in FIG. 2 are referred to by the same reference signs as those shown in FIG. 2.

The control unit 63 has both the function of the control unit 40 shown in FIG. 2 and the function of the control unit 50 shown in FIG. 2. The control unit 63 executes the process shown in FIGS. 25, 29, 30, or 31.

Each aspect of the present invention may include a following modified example. The endoscope device 10b includes the main unit 5b (a housing) to which the insertion unit 2 is connected and which includes the first operation device (the touch panel 54 and the operation button 55) and the control unit 63.

In the second modified example of the first embodiment, similarly to the first embodiment, the endoscope system 1 can cause the user to be aware that the user has forgotten carrying the external device 7 and improve the inspection efficiency.

### Third modified example of first embodiment

A third modified example of the first embodiment of the present invention will be described. The endoscope device 10 shown in FIG. 2 and the external device 7 shown in FIG. 3 are used in the third modified example of the first embodiment.

In the third modified example of the first embodiment, the processes shown in FIGS. 25 and 26 are changed.

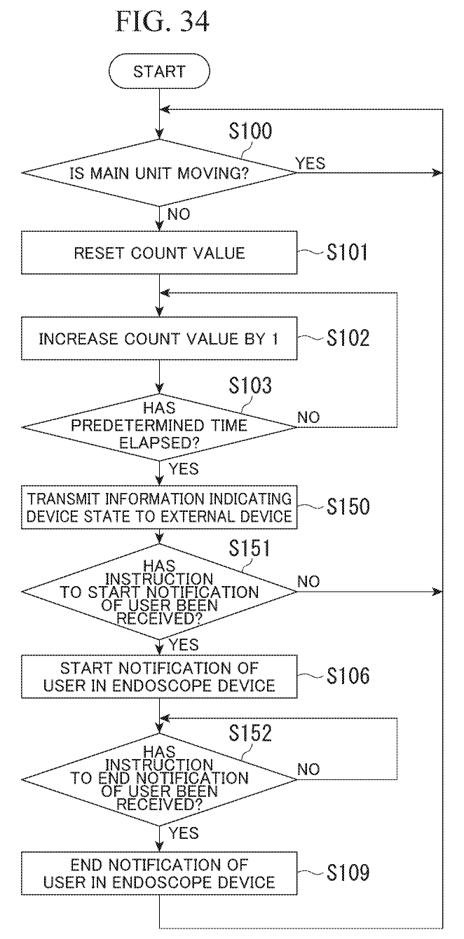

FIG. 34 shows an example of a procedure of a process executed by the endoscope device 10. The process shown in FIG. 34 corresponds to the first example shown in FIGS. 15 and 16. The control unit 50 of the main unit 5 executes the process shown in FIG. 34. The control unit 40 of the base unit 4 and the control unit 50 of the main unit 5 may share the process shown in FIG. 34. In this case, the communication unit 42 and the communication unit 57 execute communication of information required for the process. The same processes as those in the process shown in FIG. 25 will not be described.

When the control unit 50 determines that the predetermined time has elapsed in Step S103, the control unit 50 outputs information indicating the device state to the communication unit 58. The information indicates that the predetermined time has elapsed. The communication unit 58 transmits the information to the communication unit 72 (Step S150).

After Step S150, the control unit 50 determines whether an instruction to start notification of a user has been received (Step S151).

When the control unit 50 determines that the instruction to start notification of a user has not been received in Step S151, Step S100 is executed. When the control unit 50 determines that the instruction to start notification of a user has been received in Step S151, Step S106 is executed.

After S106, the control unit 50 determines whether an instruction to end notification of a user has been received (Step S152).

When the control unit 50 determines that the instruction to end notification of a user has not been received in Step S152, the control unit 50 executes the determination of Step S152 again. When the control unit 50 determines that the instruction to end notification of a user has been received in Step S152, Step S109 is executed. After Step S109, Step S100 is executed.

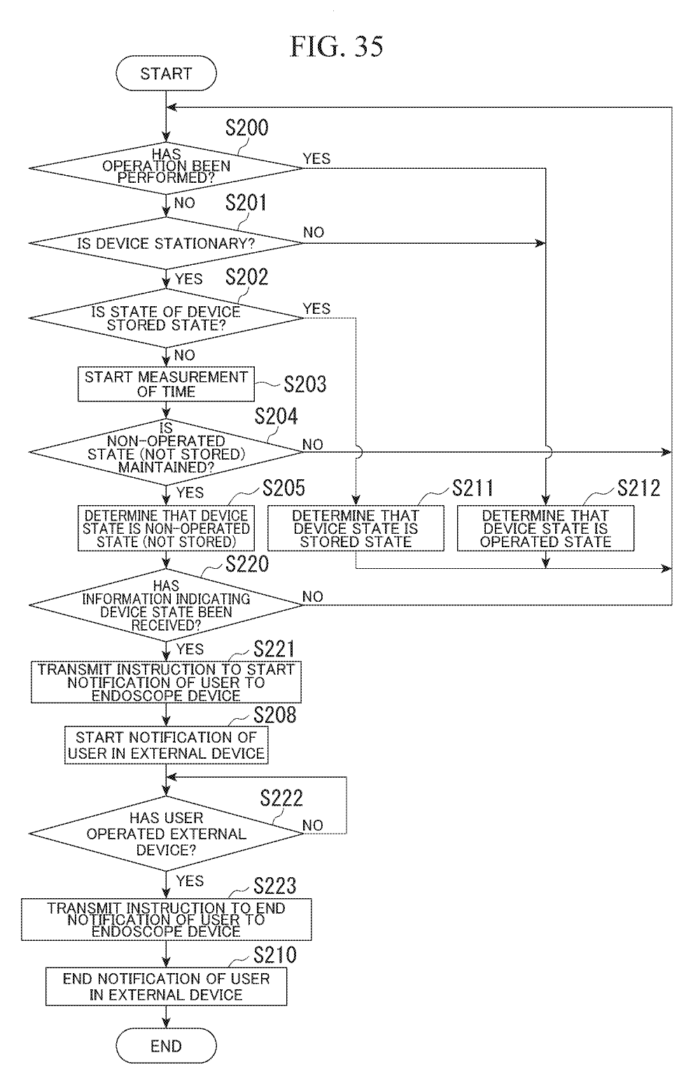

FIG. 35 shows an example of a procedure of a process executed by the external device 7. The process shown in FIG. 35 corresponds to the first example shown in FIGS. 15 and 16. The same processes as those in the process shown in FIG. 26 will not be described.

After Step S205, the control unit 70 determines whether information indicating the device state of the endoscope device 10 has been received (Step S220).

When the control unit 70 determines that the information indicating the device state of the endoscope device 10 has not been received in Step S220, Step S200 is executed. When the control unit 70 determines that the information indicating the device state of the endoscope device 10 has been received in Step S220, the control unit 70 outputs an instruction for the endoscope device 10 to start notification of a user to the communication control unit 73. The communication control unit 73 controls the communication unit 72 such that the instruction is transmitted to the communication unit 58 (Step S221).

After Step S221, Step S208 is executed. After Step S208, the control unit 70 determines whether the user has operated the external device 7 (Step S222).

When the control unit 70 determines that the user has not operated the external device 7 in Step S222, the control unit 70 executes the determination of Step S222 again. When the control unit 70 determines that the user has operated the external device 7 in Step S222, the control unit 70 outputs an instruction to end notification of a user to the communication control unit 73. The communication control unit 73 controls the communication unit 72 such that the instruction is transmitted to the communication unit 58 (Step S223). After Step S223, Step S210 is executed.

In the example shown in FIG. 34, the control unit 50 determines the device state of the main unit 5 based on the moving state (first state information) of the main unit 5 and an inspection time (first state information). In the example shown in FIG. 35, the control unit 70 determines the device state of the external device 7 based on the operation state (second operation information) of the external device 7, the moving state (second state information) of the external device 7, and the posture (second state information) of the external device 7. The control unit 70 determines whether notification of a user is necessary based on the device state of the main unit 5 and the device state of the external device 7.

Steps S101 to S103 shown in FIG. 34 may be replaced with Step S120 shown in FIG. 29. Steps S101 to S103 shown in FIG. 34 may be replaced with Step S130 shown in FIG. 30. Steps S101 to S103 shown in FIG. 34 may be replaced with Steps S140 to S143 shown in FIG. 31.

Each aspect of the present invention may include a following modified example. The communication unit 58 transmits at least one of the first operation information and the first state information to the communication unit 72. The control unit 70 executes the determination process.

Each aspect of the present invention may include a following modified example. The control unit 50 determines the execution state of inspection in the endoscope device 10 based on at least one of the first operation information and the first state information. The communication unit 58 transmits state information indicating the execution state of inspection to the communication unit 72. The control unit 70 executes the determination process based on the state information received by the communication unit 72, the second operation information, and the second state information.

In the third modified example of the first embodiment, similarly to the first embodiment, the endoscope system 1 can cause the user to be aware that the user has forgotten carrying the external device 7 and improve the inspection efficiency.

### Second embodiment

A second embodiment of the present invention will be described. The endoscope device 10 shown in FIG. 2 and the external device 7 shown in FIG. 3 are used in the second embodiment.

In the second embodiment, wireless connection between the main unit 5 and the external device 7 is cut off while inspection is being performed. After the wireless connection has been cut off, the main unit 5 and the external device 7 cannot receive information used to determine whether notification of a user is necessary from the other device. Accordingly, the endoscope system 1 immediately executes notification of a user in a situation in which there is a likelihood that the user has forgotten carrying the external device 7.

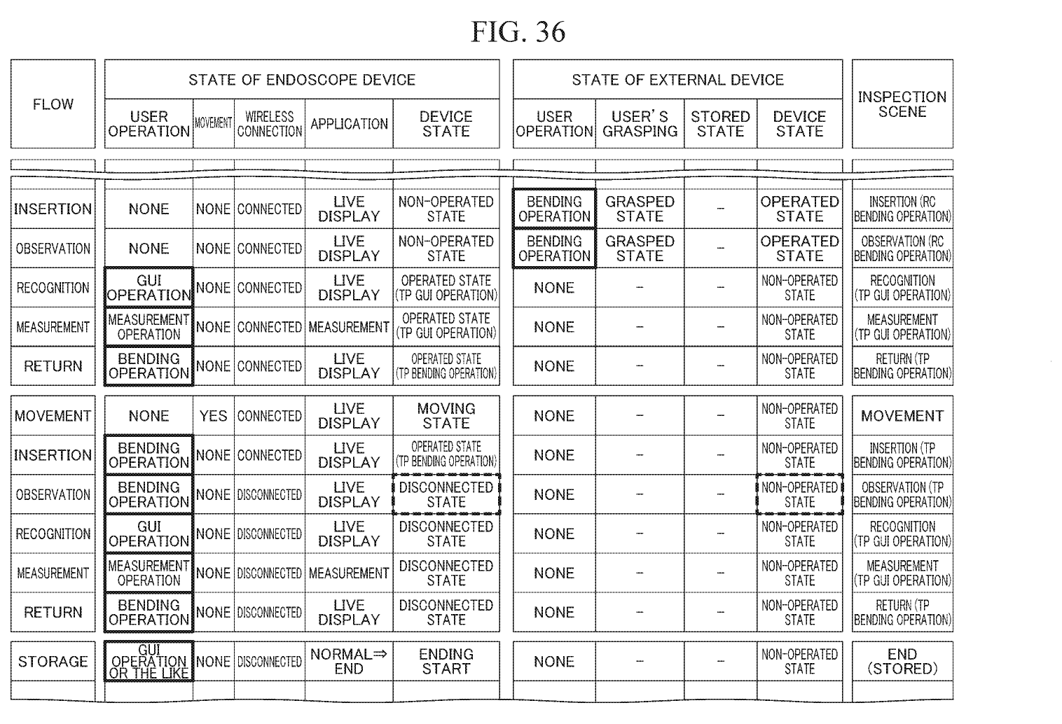

FIG. 36 shows an example of the device states and the inspection scenes. The same parts as those shown in FIG. 10 will not be described.

In the observation step that is executed again, wireless connection between the main unit 5 and the external device 7 is cut off. The device state of the external device 7 in the observation step is a disconnected state. The state in which the wireless connection is cut off is maintained in the recognition step, the measurement step, and the return step.

The device state of the endoscope device 10 is an arbitrary state, and the device state of the external device 7 is the non-operated state. For example, as shown in FIG. 36, in the recognition step, the device state of the endoscope device 10 is the operated state corresponding to the operation of the touch panel 54 (TP GUI operation), and the device state of the external device 7 is the non-operated state. At this time, there is a likelihood that the user has forgotten carrying the external device 7.

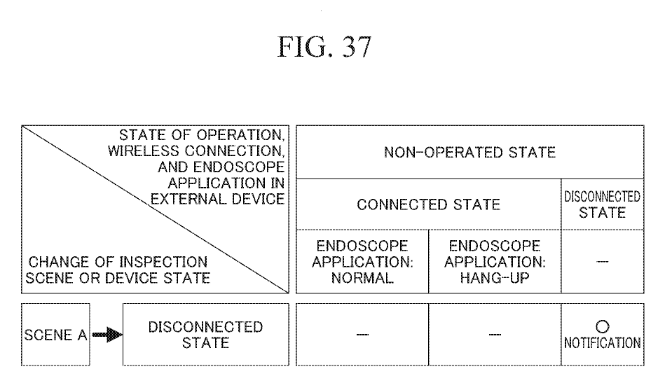

FIG. 37 shows an example of a situation in which notification of a user is necessary in accordance with the change of the inspection scene, the operation state of the external device 7, the state of the wireless connection, and the state of the endoscope application.

When the external device 7 is being operated, the user grasps the external device 7. Accordingly, notification of the user is not necessary. FIG. 37 shows an example of a situation in which notification of a user is necessary in the non-operated state. When the device state has changed from a state in which the inspection scene is an arbitrary scene A to a disconnected state, the endoscope system 1 notifies the user that the user has forgotten carrying the external device 7.

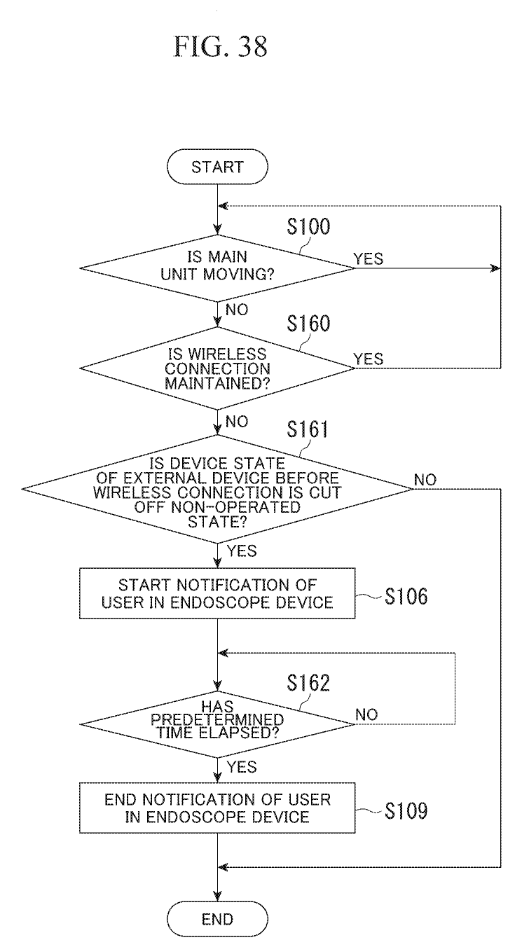

FIG. 38 shows an example of a procedure of a process executed by the endoscope device 10. The control unit 50 of the main unit 5 executes the process shown in FIG. 38. The control unit 40 of the base unit 4 and the control unit 50 of the main unit 5 may share the process shown in FIG. 38. In this case, the communication unit 42 and the communication unit 57 execute communication of information required for the process. The same processes as those in the process shown in FIG. 25 will not be described.

When the control unit 50 determines that the main unit 5 is stationary in Step S100, the control unit 50 determines whether the wireless connection between the main unit 5 and the external device 7 is maintained (Step S160).

When the control unit 50 determines that the wireless connection is maintained in Step S160, Step S100 is executed. When the control unit 50 determines that the wireless connection is cut off in Step S160, the control unit 50 determines whether the device state of the external device 7 is a non-operated state based on information received from the external device 7 before the wireless connection is cut off (Step S161).

When the control unit 50 determines that the device state of the external device 7 is not the non-operated state in Step S161, the process shown in FIG. 38 ends. When the control unit 50 determines that the device state of the external device 7 is the non-operated state in Step S161, Step S106 is executed.

After Step S106, the control unit 50 determines whether a predetermined time has elapsed from the timing at which notification of a user has been executed (Step S162).

When the control unit 50 determines that the predetermined time has not elapsed from the timing at which notification of a user has been executed in Step S162, the control unit 50 executes the determination of Step S162 again. When the control unit 50 determines that the predetermined time has elapsed from the timing at which notification of a user has been executed in Step S162, Step S109 is executed.

The control unit 50 may not execute Step S100 but execute Step S160.

The external device 7 executes the process shown in FIG. 26. The process executed by the external device 7 will not be described.

In the example shown in FIG. 38, the control unit 50 determines the device state of the main unit 5 based on the moving state (first state information) of the main unit 5 and the state of the wireless connection (first state information) between the external device 7 and the main unit 5. The control unit 50 determines whether notification of the user is necessary based on the device state of the main unit 5 and the device state of the external device 7.

The process shown in FIG. 26 may be modified. After Step S205 shown in FIG. 26, the control unit 70 may determine whether the wireless connection is maintained. When the control unit 70 determines that the wireless connection is cut off, the control unit 70 may start notification of the user.

Each aspect of the present invention may include a following modified example. At least one of the control unit of the endoscope device 10 and the control unit 70 executes the determination process based on at least one of the first operation information and the first state information indicating the state of wireless connection between the communication unit 58 and the communication unit 72 and based on the second operation information and the second state information.

In the second embodiment, when the wireless connection between the main unit 5 and the external device 7 is cut off and there is a likelihood that the user has forgotten carrying the external device 7, the endoscope system 1 executes notification of a user. The endoscope system 1 can cause the user to be aware that the user has forgotten carrying the external device 7 and improve the inspection efficiency.

### Third embodiment

A third embodiment of the present invention will be described. The endoscope device 10 shown in FIG. 2 and the external device 7 shown in FIG. 3 are used in the third embodiment.

In the third embodiment, the endoscope application hangs up while inspection is being performed. The state of the endoscope application having hung up is abnormal. After the application has hung up, the main unit 5 cannot determine whether notification of the user is necessary, and the external device 7 cannot receive information used to determine whether notification of the user is necessary from the main unit 5. Accordingly, the endoscope system 1 immediately executes notification of a user in a situation in which there is a likelihood that the user has forgotten carrying the external device 7.

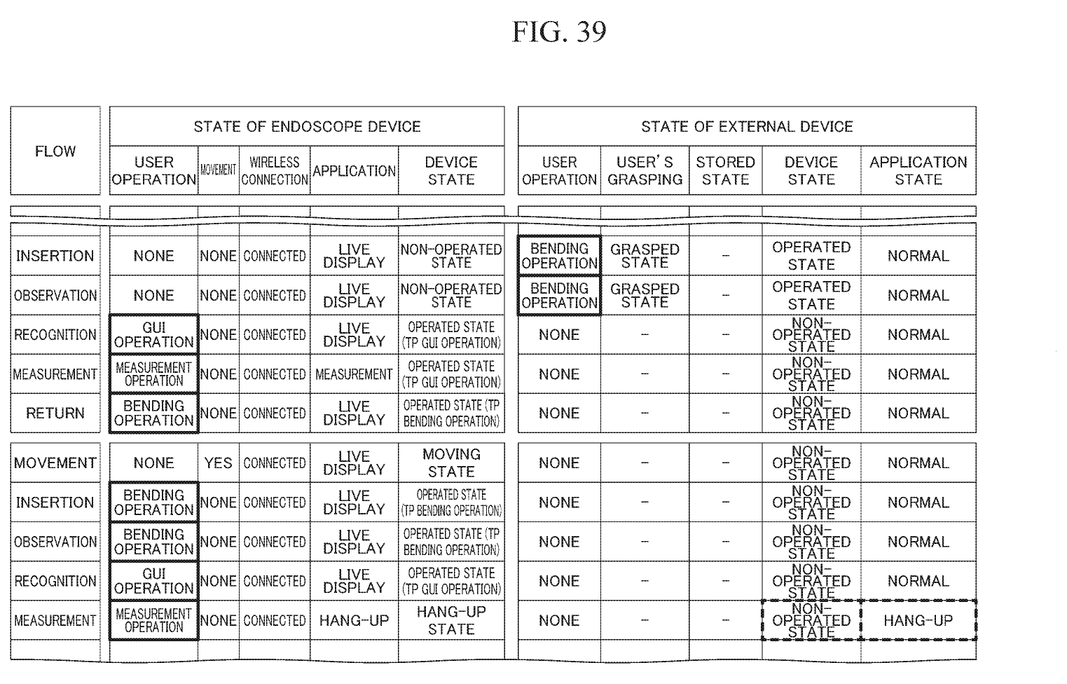

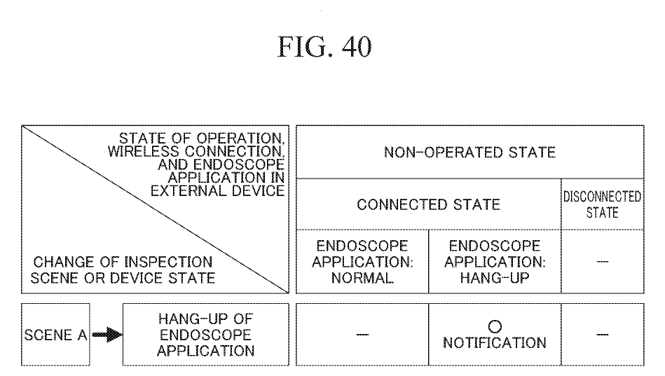

FIG. 39 shows an example of the device states. The same parts as those shown in FIG. 10 will not be described.

While the endoscope application is operating normally, the control unit 50 of the endoscope device 10 consecutively generates a health check command and outputs the health check command to the communication unit 58. The communication unit 58 transmits the health check command to the communication unit 72 at intervals of a predetermined time. The communication unit 72 receives the health check command and outputs the health check command to the control unit 70 via the communication control unit 73. When the health check command is being consecutively received, the control unit 70 determines that the endoscope application is normal.

In the measurement step, the endoscope application hangs up. Accordingly, the control unit 70 cannot determine the device state of the endoscope device 10 and cannot generate a health check command. The communication unit 58 does not transmit a health check command. The control unit 70 determines that a health check command is not received and determines that the application has hanged up.

FIG. 40 shows an example of a situation in which notification of a user is necessary in accordance with the change of the inspection scene, the operation state of the external device 7, the state of the wireless connection, and the state of the endoscope application.

When the external device 7 is being operated, the user grasps the external device 7. Accordingly, notification of the user is not necessary. FIG. 40 shows an example of a situation in which notification of a user is necessary in the non-operated state. When the endoscope application has hanged up, the endoscope system 1 notifies the user that the user has forgotten carrying the external device 7.

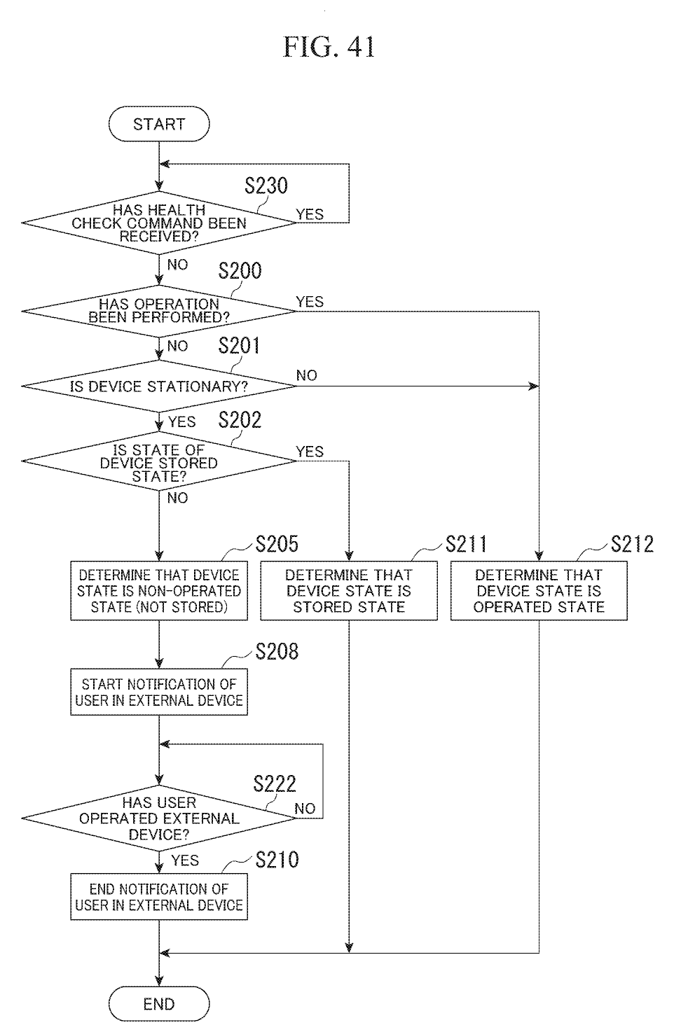

FIG. 41 shows an example of a procedure of a process executed by the external device 7. The same processes as those in the process shown in FIG. 35 will not be described.

The control unit 70 determines whether a health check command has been received (Step S230). When the control unit 70 determines that the health check command has been received in Step S230, the control unit 70 executes the determination of Step S230 again. When the control unit 70 determines that the health check command has not been received in Step S230, Step S200 is executed.

When the control unit 70 determines that the state of the external device 7 is not the stored state in Step S202, Step S205 is executed. After Step S205 has been executed, Step S208 is executed.

In the example shown in FIG. 41, the control unit 70 determines the device state of the main unit 5 based on the state of the endoscope application (first state information). The control unit 70 determines the device state of the external device 7 based on the operation state (second operation information) of the external device 7, the moving state (second state information) of the external device 7, and the posture (second state information) of the external device 7. The control unit 70 determines whether notification of the user is necessary based on the device state of the main unit 5 and the device state of the external device 7.

Each aspect of the present invention may include a following modified example. The communication unit 58 consecutively transmits a health check command (signal) to the communication unit 72. When the communication unit 72 cannot receive a health check command from the communication unit 58, the control unit 70 executes the determination process.

In the third embodiment, when the endoscope application has hanged up and there is a likelihood that a user has forgotten carrying the external device 7, the endoscope system 1 executes notification of the user. The endoscope system 1 can cause the user to be aware that the user has forgotten carrying the external device 7 and improve the inspection efficiency.

While preferred embodiments of the invention have been described and shown above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An endoscope system comprising:
an endoscope device including:
an insertion unit that is bendable and is configured to acquire an optical image in an observation target;
a first operation device configured to receive an operation including a bending operation for bending the insertion unit;
a first processor configured to acquire at least one of first operation information and first state information, the first operation information indicating an operation received by the first operation device, the first state information indicating a state of the endoscope device; and
a first communicator configured to execute wireless communication associated with control of the endoscope device; and
an external device including:
a second operation device configured to receive an operation including the bending operation;
a second sensor configured to determine a state of the external device;
a second processor configured to acquire second operation information and second state information, the second operation information indicating the operation received by the second operation device, the second state information indicating the state determined by the second sensor; and
a second communicator configured to execute the wireless communication,
wherein at least one of the first processor and the second processor is configured to execute a determination process of determining whether the external device is stored in a storage portion and whether the external device is being operated based on at least one of the first operation information and the first state information and based on the second operation information and the second state information,
wherein at least one of the first processor and the second processor is configured to cause a notification circuit included in the endoscope device or the external device to execute notification of information when it is determined that the external device is not stored in the storage portion and the external device is not being operated,
wherein the second communicator is configured to transmit the second operation information and the second state information to the first communicator when the first processor is configured to execute the determination process, and
wherein the first communicator is configured to transmit at least one of the first operation information and the first state information to the second communicator when the second processor is configured to execute the determination process.

2. The endoscope system according to claim 1,
wherein the endoscope device further includes a first sensor configured to determine a state of the endoscope device, and
wherein at least one of the first processor and the second processor is configured to execute the determination process based on at least one of the first operation information and the first state information indicating the state determined by the first sensor and based on the second operation information and the second state information.

3. The endoscope system according to claim 2,
wherein the first sensor is configured to determine a moving state of the endoscope device.

4. The endoscope system according to claim 1, wherein the second sensor is configured to determine a moving state of the external device and a posture of the external device.

5. The endoscope system according to claim 4, wherein at least one of the first processor and the second processor is configured to execute the determination process based on at least one of the first operation information and the first state information and based on the second operation information and the second state information indicating whether the external device is stationary in a preset posture.

6. The endoscope system according to claim 5,
wherein the endoscope device further includes a first sensor configured to determine a posture of the endoscope device,
wherein the first communicator is configured to transmit information indicting the posture determined by the first sensor to the second communicator,
wherein the second processor is configured to set a threshold value based on the posture indicated by the information received by the second communicator, and
wherein the second processor is configured to generate the second state information indicating whether the external device is stationary in the preset posture based on the posture determined by the second sensor and the threshold value.

7. The endoscope system according to claim 1, wherein at least one of the first processor and the second processor is configured to execute the determination process based on at least one of the first operation information and the first state information indicating a state of wireless connection between the first communicator and the second communicator and based on the second operation information and the second state information.

8. The endoscope system according to claim 1,
wherein the first communicator is configured to continuously transmit a signal to the second communicator, and
wherein the second processor is configured to execute the determination process when the second communicator does not receive the signal from the first communicator.

9. The endoscope system according to claim 1, wherein at least one of the first processor and the second processor is configured to execute the determination process based on at least one of the first operation information indicating the bending operation or an operation on an application in the endoscope device and the first state information and based on the second operation information and the second state information.

10. The endoscope system according to claim 1,
wherein at least one of the first processor and the second processor is configured to cause the notification circuit to continuously execute the notification of the information after the notification has been started,
wherein at least one of the first processor and the second processor is configured to determine whether the notification of the information is to end based on at least one of the second operation information and the second state information, and
wherein at least one of the first processor and the second processor is configured to cause the notification circuit to end the notification of the information when it is determined that the notification of the information is to end.

11. The endoscope system according to claim 1,
wherein the endoscope device further includes a global positioning system (GPS) sensor configured to determine a position of the endoscope device,
wherein the first communicator is configured to transmit information indicating the position to the second communicator when the second processor is configured to execute the determination process, and
wherein at least one of the first processor and the second processor is configured to control the notification executed by the notification circuit based on the position.

12. The endoscope system according to claim 1, wherein at least one of the first processor and the second processor is configured to control the notification executed by the notification circuit based on a current time.

13. The endoscope system according to claim 1,
wherein the second communicator is configured to transmit the second operation information and the second state information to the first communicator, and
wherein the first processor is configured to execute the determination process.

14. The endoscope system according to claim 1,
wherein the second processor is configured to determine an execution state of inspection in the external device based on the second operation information and the second state information,
wherein the second communicator is configured to transmit state information indicating the execution state to the first communicator, and
wherein the first processor is configured to execute the determination process based on at least one of the first operation information and the first state information and based on the state information received by the first communicator.

15. The endoscope system according to claim 1,
wherein the first communicator is configured to transmit at least one of the first operation information and the first state information to the second communicator, and
wherein the second processor is configured to execute the determination process.

16. The endoscope system according to claim 1,
wherein the first processor is configured to determine an execution state of inspection in the endoscope device based on at least one of the first operation information and the first state information,
wherein the first communicator is configured to transmit state information indicating the execution state to the second communicator, and
wherein the second processor is configured to execute the determination process based on the state information received by the second communicator, the second operation information, and the second state information.

17. The endoscope system according to claim 1,
wherein the endoscope device further includes:
a first housing to which the insertion unit is connected; and
a second housing including the first operation device and the first processor.

18. The endoscope system according to claim 1, wherein the endoscope device includes a housing to which the insertion unit is connected and in which the first operation device and the first processor are stored.

19. The endoscope system according to claim 1, wherein the second operation device includes a joystick configured to receive the bending operation.

20. An information notification method comprising:
causing a first processor of an endoscope device to acquire at least one of first operation information and first state information, the first operation information indicating an operation received by a first operation device configured to receive an operation including a bending operation for bending an insertion unit that is bendable and is configured to acquire an optical image in an observation target, the first state information indicating a state of the endoscope device;
causing a second processor of an external device to acquire second operation information and second state information, the second operation information indicating an operation received by a second operation device configured to receive an operation including the bending operation in the external device, the second state information indicating a state determined by a second sensor of the external device;
causing at least one of the first processor and the second processor to execute a determination process of determining whether the external device is stored in a storage portion and whether the external device is being operated based on at least one of the first operation information and the first state information and based on the second operation information and the second state information;
causing a notification circuit included in the endoscope device or the external device to execute notification of information when it is determined that the external device is not stored in the storage portion and the external device is not being operated;
causing a second communicator configured to execute wireless communication associated with control of the endoscope device to transmit the second operation information and the second state information to a first communicator configured to execute the wireless communication when the first processor is configured to execute the determination process; and
causing the first communicator to transmit at least one of the first operation information and the first state information to the second communicator when the second processor is configured to execute the determination process.

21. A non-transitory computer-readable recording medium storing a program causing a computer of an endoscope device to execute:
acquiring at least one of first operation information and first state information, the first operation information indicating an operation received by a first operation device configured to receive an operation including a bending operation for bending an insertion unit that is bendable and is configured to acquire an optical image in an observation target, the first state information indicating a state of the endoscope device;
causing a first communicator configured to execute wireless communication associated with control of the endoscope device with a second communicator of an external device to receive second operation information and second state information, the second operation information indicating an operation received by a second operation device configured to receive an operation including the bending operation in the external device, the second state information indicating a state determined by a second sensor of the external device;
executing a determination process of determining whether the external device is stored in a storage portion and whether the external device is being operated based on at least one of the first operation information and the first state information and based on the second operation information and the second state information; and
causing a notification circuit included in the endoscope device or the external device to execute notification of information when it is determined that the external device is not stored in the storage portion and the external device is not being operated.

22. A non-transitory computer-readable recording medium storing a program causing a computer of an external device to execute:
causing a second communicator configured to execute wireless communication associated with control of an endoscope device with a first communicator of the endoscope device to receive at least one of first operation information and first state information, the first operation information indicating an operation received by a first operation device configured to receive an operation including a bending operation for bending an insertion unit that is bendable and is configured to acquire an optical image in an observation target, the first state information indicating a state of the endoscope device;
acquiring second operation information and second state information, the second operation information indicating an operation received by a second operation device configured to receive an operation including the bending operation in the external device, the second state information indicating a state determined by a second sensor of the external device;
executing a determination process of determining whether the external device is stored in a storage portion and whether the external device is being operated based on at least one of the first operation information and the first state information and based on the second operation information and the second state information; and
causing a notification circuit included in the endoscope device or the external device to execute notification of information when it is determined that the external device is not stored in the storage portion and the external device is not being operated.
